(19) United States
(12) Patent Application Publication
(10) Pub. No.: US 2016/0368251 A1
(43) Pub. Date: Dec. 22, 2016

(54) SHRINK LABEL

(71) Applicant: FUJI SEAL INTERNATIONAL, INC., Osaka-shi (JP)

(72) Inventors: Shinji Banno, Osaka-shi (JP); Takahiro Kameo, Osaka-shi (JP); Eiji Hikida, Osaka-shi (JP); Shuhei Eishima, Osaka-shi (JP)

(21) Appl. No.: 14/901,259

(22) PCT Filed: Jun. 27, 2014
(86) PCT No.: PCT/JP2014/067163

§ 371 Date: Dec. 28, 2015

(30) Foreign Application Priority Data
Jun. 28, 2013 (JP) 2013-137596

(51) Int. Cl. B32B 27/32; G09F 3/00; G09F 3/02; B32B 7/02; B32B 27/08

(52) U.S. Cl. CPC B32B 27/325; B32B 27/32; B32B 7/02; B32B 27/08; G09F 3/02; G09F 3/0291; B32B 2519/00; B32B 2323/10; B32B 2307/412; B32B 2307/702; B32B 2307/736; G09F 2003/0272; G09F 2003/0251; G09F 2003/0257

(57) ABSTRACT

To provide an olefinic shrink label that includes an olefinic shrink film having excellent stretchability. The shrink label offers stiffness, transparency, and heat shrinkability at excellent levels and has a low specific gravity. A shrink label according to the present invention includes a shrink film. The shrink film includes a base layer part, and two surface layers disposed on or over both sides of the base layer part. The surface layers each contain an amorphous cycloolefin polymer in a content of equal to or more than 50 percent by weight. The base layer part includes 5 to 65 layers. The layers constituting the base layer part include at least one layer (resin layer (A)) that contains a polyolefin resin in a content of equal to or more than 50 percent by weight.

### TECHNICAL FIELD

The present invention relates to shrink labels. More specifically the present invention relates to a shrink label that is suitable for uses in which the shrink label is applied to containers for foodstuffs, toiletries (toiletry products), pharmaceuticals, beverages, and any other applications.

### BACKGROUND ART

Plastic bottles such as PET bottles, and metal bottles such as bottle-shaped cans are now widely used as containers for beverages such as tea or soft drinks. These containers are often equipped with plastic labels for labeling (indication), decoration, and/or functionalization. Typically, there are shrink labels each including a shrink film (heat-shrinkable film) and a print layer disposed on the shrink film. The shrink labels have advantages as follows and are widely used. For example, the shrink labels offer decorativeness and workability (conformability to the container) and have wide display areas.

The shrink films are made of materials such as poly(vinyl chloride)s, polyesters, polystyrenes, and polyolefins. These materials are used according to properties or characteristics of the materials. Among them, olefinic shrink films (shrink films made from polyolefins) are advantageous. For example, the olefinic shrink films do not emit harmful gases upon incineration, have a low density (low specific gravity) and a light weight, and, when they are to be recovered, can be easily separated from PET bottles and other containers by using the difference in density. Disadvantageously, however, an olefinic shrink film such as a polypropylene film, when used alone, is inferior in properties such as low-temperature shrinkage properties, seaming ability (center-seal ability) to form a cylindrical film, and printability. To improve these disadvantages, there are used or known some shrink films. For example, known multilayer shrink films each include a film layer, and surface layers disposed on both sides of the film layer. The film layer includes a propylene copolymer, and the surface layers include a cycloolefin resin (see, for example, Patent Literature (PTL) 1 and PTL 2). The surface cycloolefin resin layer of the above-mentioned shrink films may suffer from hazing or whitening caused by fats and oils. To eliminate or minimize this disadvantage, a known shrink film contains a polyethylene in the surface layers (see, for example, PTL 3). Another known shrink film includes a propylene copolymer added with a polyethylene and/or a cycloolefin polymer (see, for example, PTL 4). This configuration is intended to allow the shrink film to have higher interlaminar strengths and better shrinkage properties.

### CITATION LIST

### Patent Literature

PTL 1: Japanese Unexamined Patent Application Publication (JP-A) No. 2000-159946

PTL 2: JP-A No. 2002-215044

PTL 3: JP-A No. 2002-234115

PTL 4: JP-A No. 2004-170468

### SUMMARY OF INVENTION

### Technical Problem

There is a need for reduction in thickness (reduction in film thickness) of shrink labels. This is required from the viewpoint of cost reduction and resources saving. With a decreasing thickness, however, the shrink labels have decreasing stiffness and hardness (label hardness). This readily causes the shrink labels to disadvantageously suffer from poor application when the labels are applied to bottles using a labeler. A conventional shrink label, when including a thinner shrink film so as to have a smaller total thickness, tends to have lower stretchability, to become susceptible to rupture after stretching, and to become susceptible to natural contraction. Therefore, under present circumstances, there is a need for olefinic shrink labels that have excellent stiffness and excellent stretchability even when the labels are designed to have a smaller thickness. In addition, such shrink labels require excellent transparency and high thermal shrinkage percentages.

Specifically the present invention has an object to provide an olefinic shrink label that includes an olefinic shrink film having excellent stretchability, offers excellent stiffness, high transparency, and excellent heat shrinkability (namely, has a high heat shrinkage percentage), and has a low specific gravity.

### Solution to Problem

After intensive investigations to achieve the object, the present inventors have found a shrink label including a specific shrink film. This shrink film includes a base layer part, and surface layers disposed on or over both sides of the base layer part. The surface layers each contain an amorphous cycloolefin polymer, where the amorphous cycloolefin polymer is a principal component. The base layer part includes 5 to 65 layers. The layers constituting the base layer part include a resin layer containing a polyolefin resin, where the polyolefin resin is a principal component. The present inventors have found that the shrink label having this configuration can be an olefinic shrink label that includes an olefinic shrink film having excellent stretchability, offers stiffness, transparency, and heat shrinkability at excellent levels, and has a low specific gravity. The present invention has been made based on these findings.

Specifically, the present invention provides a shrink label including a shrink film. The shrink film includes a base layer part and two surface layers. The surface layers are respectively disposed on or over the both sides of the base layer part. The surface layers each contain an amorphous cycloolefin polymer in a content of equal to or more than 50 percent by weight. The base layer part includes 5 to 65 layers. The 5 to 65 layers include at least one resin layer (A). The at least one resin layer (A) contains a polyolefin resin in a content of equal to or more than 50 percent by weight.

The base layer part in the shrink label may include two or more plies of the resin layer (A).

The layers constituting the base layer part in the shrink label may further include at least one resin layer (B). The at least one resin layer (B) is a resin layer containing at least one of an amorphous cycloolefin polymer and an ionomer. The total content of the amorphous cycloolefin polymer and the ionomer in the resin layer (B) may be higher than the total content of amorphous cycloolefin polymers and ionomers in the resin layer (A).

The layers constituting the base layer part in the shrink label may further include at least one resin layer (B). The at least one resin layer (B) is a resin layer containing a polyolefin resin. The polyolefin resin in the resin layer (B) has a density higher than the density of the polyolefin resin in the resin layer (A).

The base layer part in the shrink label may have two or more interfaces each between an adjacent pair of the resin layer (A) and the resin layer (B).

The layers constituting the base layer part in the shrink label may further include resin layers (B). The base layer part may include the resin layers (A) and the resin layers (B) disposed in alternate order in a total number of 5 to 65.

### Advantageous Effects of Invention

The shrink label according to the present invention uses a specific shrink film as a label base. The shrink film includes a base layer part, and surface layers disposed on or over the both sides of the base layer part. The base layer part includes 5 to 65 layers. The layers constituting the base layer part include at least one resin layer (A). The surface layers each contain an amorphous cycloolefin polymer, where the amorphous cycloolefin polymer is a principal component. The resin layer (A) is a resin layer containing a polyolefin resin, where the polyolefin resin is a principal component. This configuration may allow the shrink label according to the present invention to have a low specific gravity and offers excellent stiffness even when having a smaller total thickness. The shrink label also has transparency and heat shrinkability at excellent levels. In addition, since the shrink label according to the present invention includes the shrink film having excellent stretchability, the shrink label resists natural contraction.

### BRIEF DESCRIPTION OF DRAWINGS

FIG. 1 is a schematic view (local sectional view) of a shrink label according to an embodiment of the present invention.

FIG. 2 is a schematic view (local sectional view) of a shrink label according to another embodiment of the present invention.

FIG. 3 is a schematic view (local sectional view) of a shrink label according to yet another embodiment of the present invention.

FIG. 4 is a schematic view (local sectional view) of a shrink label according to still another embodiment of the present invention.

FIG. 5 is a schematic view of a shrink sleeve label that is a shrink label according to an embodiment of the present invention.

FIG. 6 is a schematic view of the shrink sleeve label that is the shrink label according to the embodiment of the present invention. The schematic view is an enlarged view of the essential parts of a cross section taken along the line A-A′ in FIG. 5.

### DESCRIPTION OF EMBODIMENTS

The shrink label according to the present invention is a shrink label including a shrink film. The shrink film (specifically, the shrink film included in the shrink label according to the present invention) is also referred to as a “shrink film in the present invention” in the present description. In addition to the shrink film in the present invention, the shrink label according to the present invention may further include one or more other layers within ranges not adversely affecting the advantageous effects of the present invention.

### Shrink Film

The shrink film in the present invention includes surface layers respectively disposed on or over both sides of a base layer part. Specifically, the shrink film in the present invention has a layer configuration including at least one surface layer, the base layer part, and at least one surface layer disposed in this order. The shrink film may include an adhesive layer and any other layer between the base layer part and the surface layers, but preferably includes the base layer part, and the surface layers each directly disposed on the base layer part. The surface layers disposed on or over both sides of the base layer part may be layers identical to, or different from each other, as long as meeting conditions for the surface layers specified in the present application. When the surface layers are different layers, the surface layers may be different typically in composition of resins constituting the surface layers and/or different in layer thickness. The shrink film in the present invention may further include an antistatic coating layer and/or an anchor coat layer on one or both of the outer surfaces of the surface layers within ranges not adversely affecting the object of the present invention.

Surface Layers

The surface layers disposed on or over both sides of the base layer part are hereinafter also generically referred to as a “surface layer” or “surface layers”. The surface layers in the shrink film in the present invention are each independently a layer that contains an amorphous cycloolefin polymer in a content of equal to or more than 50 percent by weight. The shrink film in the present invention includes the surface layers. This configuration may allow the shrink film to resist natural contraction, to have excellent stretchability, to offer excellent transparency as surface layers, and to have excellent printability. The shrink film also has excellent seaming ability upon processing of the shrink film into a shrink sleeve label. The shrink film in the present invention, when constituting an outermost surface of the shrink label, may allow the shrink label to have excellent abrasion resistance. In addition, the shrink film may allow the shrink label according to the present invention to have a higher heat shrinkage percentage.

The surface layer contains an amorphous cycloolefin polymer, where the amorphous cycloolefin polymer is an essential component. The surface layer may contain each of different amorphous cycloolefin polymers alone or in combination. The surface layer may further contain one or more other resins in addition to the amorphous cycloolefin polymers.

Examples of the amorphous cycloolefin polymer include, but are not limited to, copolymers of an α-olefin and at least one cycloolefin; ring-opened polymers derived from cycloolefins; and hydrogenated derivatives of the ring-opened polymers. Examples of the α-olefin include, but are not limited to, ethylene, propylene, 1-butene, 1-hexene, and 4-methyl-1-pentene. The copolymers are also referred to as “cycloolefin copolymers”. The ring-opened polymers and the hydrogenated derivatives of the ring-opened polymers are also referred to as “cycloolefin ring-opened polymers and hydrogenated derivatives of them”. The cycloolefin copolymers, the cycloolefin ring-opened polymers, and the hydrogenated derivatives of the ring-opened polymers each also include corresponding graft-modified products.

One or more cycloolefins are used in the amorphous cycloolefin polymer to constitute the surface layer. The cycloolefins are exemplified by, but not limited to, polycyclic cycloolefins such as bicyclo[2.2.1]hept-2-ene (norbornene), tetracyclo[4.4.0.1^{2,5}.1^{7,10}]-3-dodecene, hexacyclo[6.6.1.1^{3,6}.1^{10,13}. 0^{2,7}.0^{9,14}]-4-heptadecene, octacyclo[8.8.0.1^{2,9}.1^{4,7}.1^{11,18}.1^{13,16}.0^{3,8}.0^{12,17}]-5-docosene, pentacyclo[6.6.1.1^{3,6}.0^{2,7}.0^{9,14}]-4-hexadecene, heptacyclo-5-icosene, heptacyclo-5-henicosene, tricyclo[4.3.0.1^{2,5}]-3-decene, tricyclo[4.4.0.1^{2,5}]-3-undecene, pentacyclo[6.5.1.1^{3,6}.0^{2,7}.0^{9,13}]-4-pentadecene, pentacyclopentadecadiene, pentacyclo[4.7.0.1^{2,5}.0^{8,13}.1^{9,12}]-3-pentadecene, and nonacyclo[9.10.1.1^{4,7}.1^{13,20}.1^{15,18}.0^{2,10}.0^{12,21}.0^{14,19}]-5-pentacosene. Among them, norbornene is preferred. These cycloolefins may each have one or more substituents on the ring. Examples of the substituents include, but are not limited to, ester groups such as methoxycarbonyl and ethoxycarbonyl groups; alkyl groups such as methyl group; haloalkyl groups; cyano group; and halogen atoms.

The cycloolefin copolymers may each be obtained typically by polymerizing the α-olefin and the cycloolefin in a hydrocarbon solvent using a catalyst. The hydrocarbon solvent is exemplified by, but not limited to, hexane, heptane, octane, cyclohexane, benzene, toluene, and xylenes. The catalyst is exemplified by, but not limited to, so-called Ziegler catalysts and metallocene catalysts. Such cycloolefin copolymers are also commercially available typically as APEL from Mitsui Chemicals Inc.; and TOPAS from Polyplastics Co., Ltd.

The cycloolefin ring-opened polymers and hydrogenated derivatives of them may each be prepared typically by subjecting one or more of the cycloolefins to metathesis polymerization (ring-opening polymerization) by the catalysis of a molybdenum compound and/or a tungsten compound to give a polymer, and, generally, further hydrogenating the formed polymer. Such cycloolefin ring-opened polymers and hydrogenated derivatives of them are also commercially available typically as ARTON from JSR Corporation; and ZEONEX and ZEONOR from ZEON CORPORATION.

Of amorphous cycloolefin polymers for use in the surface layer, cycloolefin copolymers are more preferred. Upon mixing with a polyolefin resin, the cycloolefin copolymer can be mixed with the polyolefin resin with good miscibility and compatibility. This configuration may allow the shrink film to have high transparency and excellent impact resistance.

The amorphous cycloolefin polymer for use in the surface layer may have a glass transition temperature (Tg) of preferably 50° C. to 80° C., more preferably 60° C. to 80° C., furthermore preferably 60° C. to 75° C., and most preferably 65° C. to 75° C. (in particular about 70° C.). This is preferred from the viewpoint of stretchability. The glass transition temperature of the amorphous cycloolefin polymer may be adjusted typically by the types and blending ratio of monomer components such as cycloolefins.

When one or more cycloolefin copolymers are used as the amorphous cycloolefin polymer to form the surface layer, the surface layer may contain constitutional units derived from monomer component cycloolefins (e.g., norbornene) in a content of preferably 50 to 75 percent by weight, and more preferably 60 to 70 percent by weight, based on the total weight (100 percent by weight) of cycloolefin copolymers contained in the surface layer. This is preferred from the viewpoint of shrinkage properties. Typically, the cycloolefin copolymers are preferably cycloolefin copolymers each having a norbornene content (norbornene content in COC) within the range.

The amorphous cycloolefin polymer may have a density not critical, but preferably 0.90 to 1.10 g/cm³, and more preferably 0.95 to 1.05 g/cm³. This is preferred for allowing the shrink film to have a low specific gravity. When the surface layer contains two or more different amorphous cycloolefin polymers, the density of the amorphous cycloolefin polymers is defined as the density of a mixture of all the amorphous cycloolefin polymers contained in the surface layer.

The surface layer contains the amorphous cycloolefin polymer in a content of equal to or more than 50 percent by weight, preferably equal to or more than 70 percent by weight, and more preferably equal to or more than 80 percent by weight, based on the total weight (100 percent by weight) of the surface layer. The content may be 100 percent by weight in terms of upper limit, but is preferably equal to or less than 95 percent by weight, and more preferably equal to or less than 90 percent by weight. The surface layer, if containing the amorphous cycloolefin polymer in a content of less than 50 percent by weight, may cause the shrink label to suffer from reduction in stretchability, heat shrinkage percentage, and/or printability and to have lower seaming ability upon the preparation of a shrink sleeve label. The term “content of the amorphous cycloolefin polymer” refers to the total of contents of all amorphous cycloolefin polymers contained in the surface layer.

The surface layer preferably, but not limitatively, contains a polyethylene resin. This configuration may allow the surface layer to maintain transparency and still to eliminate or minimize hazing (whitening) caused by fats/oils and any other substances (may eliminate or minimize hazing (whitening) caused by fingerprints) and may allow the shrink label to have a low specific gravity. The surface layer may contain each of different polyethylene resins alone or in combination.

The polyethylene resin is hereinafter also simply referred to as a “polyethylene”. Examples of the polyethylene include, but are not limited to, ethylene homopolymers; and copolymers (ethylene copolymers) derived from monomer components essentially including ethylene and one or more olefins (olefins excluding ethylene). Of the ethylene copolymers, preferred are copolymers (ethylene-α-olefin copolymers) derived from monomer components essentially including ethylene and one or more α-olefins. The ethylene copolymers are copolymers including a constitutional unit derived from ethylene, and a constitutional unit derived from the olefin in molecule (per molecule). The ethylene-α-olefin copolymers are copolymers including a constitutional unit derived from ethylene, and a constitutional unit derived from the α-olefin in molecule (per molecule). Preferred examples of the α-olefins for use as comonomer components to form the ethylene copolymers include, but are not limited to, C₃-C₂₀ α-olefins such as propylene, 1-butene, 1-pentene, 4-methyl-1-pentene, 1-hexene, 1-heptene, 1-octene, 1-nonene, and 1-decene. Each of different α-olefins may be used alone or in combination.

The ethylene copolymers each include constitutional units derived from ethylene in a content of preferably, but not limitatively, equal to or more than 50 percent by weight, more preferably equal to or more than 70 percent by weight, and furthermore preferably equal to or more than 85 percent by weight, based on the total weight (100 percent by weight) of all ethylene copolymers contained in the surface layer.

Examples of the polyethylene resins include, but are not limited to, low-density polyethylenes (LDPEs), linear low-density polyethylenes (LLDPEs), and medium-density polyethylenes. Among them, LDPEs and LLDPEs are preferred from the viewpoints of low specific gravity, good transparency, and good heat shrinkability. In particular, one or more LDPEs are preferably used alone or in combination with one or more LLDPEs. This is preferred from the viewpoint of transparency. Each of different LDPEs and each of different LLDPEs may be used alone or in combination.

Examples of the polyethylene resins include metallocene-catalyzed polyethylene resins which are polyethylene resins prepared via polymerization using a metallocene catalyst. Examples of the metallocene catalyst include known or common metallocene catalysts for olefin polymerization. Examples of polymerization techniques to form the polyethylene resins include, but are not limited to, known polymerization techniques such as slurry technique, solution polymerization technique, and gas phase technique.

The polyethylene resins may also be available as commercial products. Examples of the commercially available polyethylene resins include, but are not limited to, metallocene-catalyzed LLDPEs such as UMERIT 2040FC and UMERIT 1540F from UBE-MARUZEN POLYETHYLENE CO.,LTD.; Evolue SP2040 and Evolue SP0540 from Prime Polymer Co., Ltd.; and KERNEL KF260T, KERNEL KF360T, KERNEL KF380, and KERNEL KS340T from Japan Polyethylene Corporation.

The polyethylene resins may each have a density not critical, but preferably 0.850 to 0.935 g/cm³, more preferably 0.870 to 0.925 g/cm³, and furthermore preferably 0.895 to 0.920 g/cm³. This is preferred for allowing the shrink film to have a low specific gravity. When the surface layer contains two or more different polyethylene resins, the density of the polyethylene resins is defined as the density of the mixture of all the polyethylene resins contained in the surface layer.

The surface layer may contain the polyethylene resin(s) in a content not critical, but preferably less than 50 percent by weight, more preferably 5 to 30 percent by weight, and furthermore preferably 10 to 20 percent by weight, based on the total weight (100 percent by weight) of the surface layer.

In particular, the surface layer is preferably a resin layer containing the amorphous cycloolefin polymer(s) in a content of equal to or more than 70 percent by weight; and the polyethylene resin(s) in a content of 10 to 30 percent by weight based on the total weight (100 percent by weight) of the surface layer.

The surface layer may further contain one or more additives within ranges not adversely affecting the advantageous effects of the present invention. Examples of the additives include, but are not limited to, lubricants, fillers, thermal stabilizers, antioxidants, ultraviolet absorbers, antistatic agents, anti-fogging agents, flame retardants, colorants, and pinning agents (alkaline earth metals). The surface layer may contain recycled raw materials that are obtained by repelletizing film pieces formed upon film production.

The surface layer may have a density not critical, but preferably 0.85 to 1.10 g/cm³, and more preferably 0.90 to 1.05 g/cm³. The surface layer, when having a density of equal to or more than 0.85 g/cm³, may advantageously allow the shrink label to have higher stiffness. In contrast, the surface layer, when having a density of equal to or less than 1.10 g/cm³, may advantageously allow the shrink label to have a lower specific gravity.

Base Layer Part

The base layer part in the shrink film in the present invention includes 5 to 65 layers. The layers constituting the base layer part include at least one resin layer (A). The resin layer (A) is a layer containing a polyolefin resin in a content of equal to or more than 50 percent by weight. The presence of the base layer part may allow the shrink film in the present invention to give a shrink label that includes the shrink film having excellent stretchability even upon thickness reduction, offers stiffness, transparency, and heat shrinkability at excellent levels, and has a low specific gravity.

In particular, the base layer part preferably includes 5 to 65 resin layers and particularly preferably includes resin layers that occupy all of the layers constituting the base layer part.

The base layer part preferably includes at least one resin layer (B) in the layers constituting the base layer part. Though not limited, the base layer part may further include a layer E in the layers constituting the base layer part. The layer E refers to a layer other than the resin layers (A) and the resin layers (B). The layer E is preferably, but not limitatively, a resin layer having a density of equal to or less than 1.10 g/cm³, and preferably equal to or less than 1.05 g/cm³.

In the present description, a “layer containing a polyolefin resin in a content of equal to or more than 50 percent by weight” in the base layer part is also referred to as a “resin layer (A)”. Specifically, the base layer part includes at least one resin layer (A). As used herein the term “base layer part” refers to a portion disposed between the surface layers in the shrink film in the present invention. When the shrink film in the present invention includes two or more resin layers (A), all or part of the two or more resin layers (A) in the shrink film in the present invention may be layers identical to, or different from each other, as long as the layers meet the conditions for the resin layers (A) specified in the present application. For example, the resin layers (A) may differ from each other in composition of resins constituting the resin layers (A) and/or in layer thickness. Likewise, when the shrink film in the present invention includes two or more resin layers (B), all or part of the two or more resin layers (B) may be layers identical to, or different from each other. For example, the resin layers (B) may differ from each other in composition of resins constituting the resin layers (B) and/or in layer thickness. The resin layers (A) differ from the resin layers (B). When the base layer part further includes the resin layer(s) (B), the outermost layers of the base layer part, namely, layers to be in contact with the surface layers are not limited and may be either one or both of the resin layer (A) and the resin layer (B).

Resin Layer (A)

The resin layer (A) is a resin layer containing a polyolefin resin in a content of equal to or more than 50 percent by weight. The resin layer (A) is a relatively soft (flexible) resin layer. The base layer part includes at least one ply of the resin layer (A) and includes stacked multiple layers. This configuration may allow the shrink label according to the present invention to have excellent stiffness and to offer excellent heat shrinkability.

The resin layer (A) is a resin layer containing a polyolefin resin in a content of equal to or more than 50 percent by weight, preferably equal to or more than 60 percent by weight, and more preferably equal to or more than 70 percent by weight. The upper limit of the content is not critical, but may be 100 percent by weight. Since the resin layer (A) contains the polyolefin resin in a content of equal to or more than 50 percent by weight, the shrink label can have a low specific gravity. The content (in weight percent) of the polyolefin resin refers to a content based on the total weight (100 percent by weight) of the resin layer (A). When the resin layer (A) contains two or more different polyolefin resins, the content of the polyolefin resins refers to the total of the contents of all the polyolefin resins contained in the resin layer (A). In the present description, the “resin layer containing a polyolefin resin in a content of equal to or more than 50 percent by weight” is also referred to as a “resin layer containing a polyolefin resin as a main component”.

The polyolefin resin is a polymer that includes an olefin as an essential monomer component, namely, a polymer that includes an olefin in molecule (per molecule). The polyolefin resins also include olefinic elastomers. Examples of the olefin include, but are not limited to, α-olefins such as ethylene, propylene, 1-butene, and 4-methyl-1-pentene.

Examples of the polyolefin resin include, but are not limited to, polymers that are derived from monomer component(s) essentially including ethylene (polyethylene resins); polymers that are derived from monomer component(s) essentially including propylene (polypropylene resins); and ethylene-carboxylic acid copolymers and ethylene-carboxylic ester copolymers, such as ethylene-vinyl acetate copolymers (EVAs), ethylene-acrylic acid copolymers (EAAs), ethylene-methacrylic acid copolymers (EMAAs), ethylene-ethyl acrylate copolymers (EEAs), ethylene-methyl methacrylate copolymers (EMMAs), and other ethylene-(meth)acrylic ester copolymers. Among them, polyethylene resins and polypropylene resins are preferred, of which polyethylene resins are more preferred. In the present description, the “polyolefin resins” exclude amorphous cycloolefin polymers and ionomers.

Examples of the polyolefin resin include, but are not limited to, α-olefin homopolymers such as homopolypropylenes; and copolymers that are derived from monomer components essentially including two or more different α-olefins (olefin copolymers). The resin layer (A) may contain each of different polyolefin resins alone or in combination.

Examples of the polyethylene resin(s) (namely, the polyethylene resin(s) contained in the resin layer (A)) include, but are not limited to, ethylene homopolymers and ethylene copolymers. Of the ethylene copolymers, preferred are ethylene-α-olefin copolymers. The ethylene copolymers are copolymers that include a constitutional unit derived from ethylene, and a constitutional unit derived from an olefin in molecule (per molecule). Preferred examples of the α-olefin for use as a comonomer component to constitute the ethylene copolymers include, but are not limited to, C₃-C₂₀ α-olefins such as 1-butene, 1-pentene, 4-methyl-1-pentene, 1-hexene, 1-heptene, 1-octene, 1-nonene, and 1-decene. Each of different α-olefins may be used alone or in combination.

The ethylene copolymers may include ethylene-derived constitutional units in a content not critical, but preferably equal to or more than 50 percent by weight, more preferably equal to or more than 70 percent by weight, and furthermore preferably equal to or more than 85 percent by weight, based on the total weight (100 percent by weight) of all ethylene copolymers contained in the resin layer (A).

Examples of the polyethylene resin(s) (the polyethylene resin(s) contained in the resin layer (A)) include, but are not limited to, low-density polyethylenes (LDPEs), linear low-density polyethylenes (LLDPEs), ultralow-density polyethylenes, and medium-density polyethylenes. The polyethylene resin(s) is preferably, but not limitatively, selected from LDPEs and LLDPEs. This is preferred from the viewpoint of low density, good transparency, and good heat shrinkability. The resin layer (A) may include each of different polyethylene resins alone or in combination.

Examples of the polypropylene resins include, but are not limited to, homopolypropylenes and propylene copolymers. Of the propylene copolymers, preferred are propylene-α-olefin copolymers. The propylene copolymers are copolymers that include a constitutional unit derived from propylene, and a constitutional unit derived from an olefin in molecule (per molecule). Examples of the α-olefin for use as a comonomer component to constitute the propylene-α-olefin copolymers include, but are not limited to, ethylene; and C₄-C₂₀ α-olefins such as 1-butene, 1-pentene, 4-methyl-1-pentene, 1-hexene, 1-heptene, 1-octene, 1-nonene, and 1-decene. Each of different α-olefins may be used alone or in combination. The propylene copolymers (such as propylene-α-olefin copolymers) may be any of block copolymers, random copolymers, and graft copolymers.

The propylene copolymer(s) may contain propylene-derived constitutional units in a content not critical, but preferably equal to or more than 50 percent by weight, more preferably equal to or more than 70 percent by weight, and furthermore preferably equal to or more than 80 percent by weight, based on the total weight (100 percent by weight) of all propylene copolymers contained in the resin layer (A).

Of the propylene copolymers, particularly preferred are propylene-ethylene copolymers. The ratio (by weight) of ethylene to propylene in the propylene-ethylene copolymers may be selected within ranges of from about 1:99 to about 30:70, preferably from about 2:98 to about 25:75, and more preferably from about 3:95 to about 20:80. The propylene-ethylene copolymers may be any of block copolymers, random copolymers, and graft copolymers. Comonomer components to constitute the propylene-ethylene copolymers may further include one or more α-olefins excluding ethylene and propylene. The propylene copolymers (in particular, the propylene-ethylene copolymers) are preferably those having an isotactic index of equal to or more than 90%. This configuration is preferred from the viewpoint of low-temperature shrinkage properties and shrink label stiffness.

Of the propylene-ethylene copolymers, particularly preferred are propylene-ethylene graft copolymers. The propylene-ethylene graft copolymers are modified polypropylene resins that include a polypropylene backbone that is graft-copolymerized with a polyethylene resin. The use of one or more of the propylene-ethylene graft copolymers as the polyolefin resin may advantageously allow the shrink film (and shrink label) to resist natural contraction and to have a higher heat shrinkage percentage upon shrink processing.

Of the polyolefin resins, metallocene-catalyzed polyolefin resins are preferred, of which metallocene-catalyzed polyethylenes and metallocene-catalyzed polypropylenes are particularly preferred. These are preferred from the viewpoint of filming/processing suitability. The metallocene catalyst may be selected from known or common metallocene catalysts for olefin polymerization. Examples of techniques for the polymerization (techniques for the copolymerization) of the polyolefin resin include, but are not limited to, known polymerization techniques such as slurry technique, solution polymerization technique, and gas phase technique.

Of the above-mentioned polyolefin resins, metallocene-catalyzed polyethylenes and metallocene-catalyzed polypropylenes are preferred, of which metallocene-catalyzed ethylene-α-olefin copolymers and metallocene-catalyzed propylene-ethylene graft copolymers are more preferred. Of the metallocene-catalyzed ethylene-α-olefin copolymers, metallocene-catalyzed ethylene-α-olefin random copolymers are preferred, of which metallocene-catalyzed ethylene-propylene random copolymers are more preferred.

The polyolefin resin may also be available as commercial products. Examples of commercially available polyolefin resins (commercial products) include, but are not limited to, metallocene-catalyzed LLDPEs such as UMERIT 2040FC and UMERIT 1540F from UBE-MARUZEN POLYETHYLENE CO., LTD., Evolue SP2040 and Evolue SP0540 from Prime Polymer Co., Ltd., KERNEL KF260T, KERNEL KF360T, KERNEL KF380, and KERNEL KS340T from Japan Polyethylene Corporation; metallocene-catalyzed propylene-ethylene random copolymers such as WINTEC WFX6 and WINTEC 1987FC from Japan Polypropylene Corporation; polypropylene resins such as ZELAS #7000 and ZELAS #5000 from Mitsubishi Chemical Corporation; and propylene-ethylene graft copolymers such as Vistamaxx 3020FL and Vistamaxx 3980FL from ExxonMobil Chemical Company.

The polyolefin resin may have a density not critical, but preferably 0.850 to 0.935 g/cm³, more preferably 0.870 to 0.925 g/cm³, and furthermore preferably 0.895 to 0.920 g/cm³. The density within the range is preferred for allowing the shrink film to have a low specific gravity. When the resin layer (A) contains two or more different polyolefin resins, the density of the polyolefin resin is defined as the density of a mixture of all the polyolefin resins contained in the resin layer (A).

Though not limited, the resin layer (A) may further contain at least one selected from the group consisting of amorphous cycloolefin polymers and ionomers in addition to the polyolefin resins. When the resin layer (A) includes at least one selected from the group consisting of amorphous cycloolefin polymers and ionomers, the polyolefin resin contained in the resin layer (A) is preferably, but not limitatively, at least one selected from the group consisting of polyethylene resins and polypropylene resins, and particularly preferably at least one propylene-ethylene copolymer. The amorphous cycloolefin polymers and ionomers have high compatibility with polyethylene resins and polypropylene resins and each have a higher density as compared with the polyethylene resins and polypropylene resins. Assume that a resin layer mainly containing a polyethylene resin and/or a polypropylene resin further contains an amorphous cycloolefin polymer and/or an ionomer. Advantageously, the resin layer may allow the shrink film to resist natural contraction and to have better stretchability and may allow the shrink label to have higher stiffness and/or to have a higher heat shrinkage percentage, without causing the shrink film to have lower transparency. In the present description, the “amorphous cycloolefin polymers” and the “ionomers” are generically referred to as a “component (C)”. Of components (C) which may be contained in the resin layer (A), an amorphous cycloolefin polymer is preferred.

Examples of the amorphous cycloolefin polymer (namely, the amorphous cycloolefin polymer which may be contained in the resin layer (A)) include, but are not limited to, the amorphous cycloolefin polymers exemplified and described as the amorphous cycloolefin polymer to be contained in the surface layer. The amorphous cycloolefin polymer which may be contained in the resin layer (A) may be identical to, or different from, the amorphous cycloolefin polymer contained in the surface layer, but is preferably identical to the amorphous cycloolefin polymer contained in the surface layer.

Examples of the cycloolefin to form the amorphous cycloolefin polymer include, but are not limited to, the cycloolefins exemplified and described as cycloolefins to form the amorphous cycloolefin polymer contained in the surface layer. Among them, norbornene is preferred. These cycloolefins may each have one or more substituents on the ring. Examples of the substituents include, but are not limited to, ester groups such as methoxycarbonyl and ethoxycarbonyl groups; alkyl groups such as methyl group; haloalkyl groups; cyano group; and halogen atoms.

The amorphous cycloolefin polymer may also be available as commercial products. Examples of the commercially available products include the amorphous cycloolefin polymers exemplified and described as commercial products of the amorphous cycloolefin polymer contained in the surface layer.

Examples of the ionomer include, but are not limited to, ionomers each structurally including the ethylene-carboxylic ester copolymer as a base polymer, except for part or all of carboxy groups contained in the base polymer being crosslinked through a metal ion.

Examples of the metal ion contained in the ionomer include, but are not limited to, monovalent metal ions such as lithium, sodium, potassium, and cesium ions; divalent metal ions such as magnesium, calcium, strontium, barium, copper, and zinc ions; and trivalent metal ions such as aluminum and iron ions. The ionomer may include each of different metal ions alone or in combination.

Examples of the ionomer include, but are not limited to, known or common ionomers. The ionomer may also be available as commercial products. Examples of the commercially available products include, but are not limited to, products available under the trade name of HIMILAN from DUPONT-MITSUI POLYCHEMICALS CO., LTD.

When the resin layer (A) is a resin layer containing the component (C), the resin layer (A) may contain the component (C) in a content not critical, but preferably equal to or less than 50 percent by weight (e.g., 0 to 50 percent by weight), more preferably 5 to 30 percent by weight, and furthermore preferably 10 to 25 percent by weight, based on the total weight (100 percent by weight) of the resin layer (A). The content within the range is preferred from the viewpoint of low specific gravity. As used herein the “content of the component (C)” refers to the total content of amorphous cycloolefin polymers and ionomers.

The resin layer (A) may further contain one or more tackifiers such as petroleum resins. This configuration may contribute to a higher heat shrinkage percentage and higher stiffness and may eliminate or minimize natural contraction. Examples of the tackifiers include, but are not limited to, rosinous resins such as rosin, polymerized rosins, hydrogenated rosins, derivatives of these rosins, and resin acid dimers derived from the rosins; terpene resins such as terpene resins, aromatic modified terpene resins, hydrogenated terpene resins, and terpene-phenol resins; petroleum resins such as aliphatic, aromatic, and alicyclic petroleum resins. Among them, petroleum resins are preferred. The resin layer (A) may contain each of different tackifiers alone or in combination. When the resin layer (A) contain one or more tackifiers, the resin layer (A) may contain the tackifiers in a content of preferably 5 to 30 percent by weight, and more preferably 10 to 25 percent by weight, based on the total weight (100 percent by weight) of the resin layer (A). The resin layer (A), when containing the tackifiers in a content of equal to or less than 30 percent by weight, may advantageously allow the shrink film to resist embrittlement. The resin layer (A), when containing the tackifiers in a content of equal to or more than 5 percent by weight, may advantageously sufficiently enjoy the effects of the presence of the tackifiers.

The resin layer (A) may contain one or more additives within ranges not adversely affecting the advantageous effects of the present invention. Examples of the additives include, but are not limited to, lubricants, fillers, thermal stabilizers, antioxidants, ultraviolet absorbers, antistatic agents, anti-fogging agents, flame retardants, colorants, and pinning agents (alkaline earth metals). The resin layer (A) may contain recycled raw materials that are obtained by repelletizing film pieces formed upon film production.

Of the above-mentioned configurations, the resin layer (A) is particularly preferably selected from resin layers (I), (II), and (III) as follows. The resin layer (I) is a resin layer (A) that contains an LLDPE (preferably a metallocene-catalyzed LLDPE) in a content of equal to or more than 50 percent by weight based on the total weight (100 percent by weight) of the resin layer (A). The content is preferably equal to or more than 70 percent by weight, and more preferably equal to or more than 90 percent by weight from the viewpoint of the shrink film transparency. The resin layer (II) is a resin layer (A) that contains a metallocene-catalyzed polypropylene (preferably a metallocene-catalyzed propylene-ethylene graft copolymer) in a content of equal to or more than 50 percent by weight based on the total weight (100 percent by weight) of the resin layer (A). The content is preferably equal to or more than 80 percent by weight, and more preferably equal to or more than 90 percent by weight from the viewpoint of the shrink film transparency. The resin layer (III) is a resin layer (A) that contains an LLDPE (preferably a metallocene-catalyzed LLDPE) and a metallocene-catalyzed polypropylene (preferably a metallocene-catalyzed propylene-ethylene graft copolymer). In the resin layer (III), the total content of the LLDPE and the metallocene-catalyzed polypropylene is equal to or more than 50 percent by weight, preferably equal to or more than 80 percent by weight, and more preferably equal to or more than 90 percent by weight, based on the total weight (100 percent by weight) of the resin layer (A). The resin layers (I) and (III) as the resin layers (A) may further include an LDPE. The resin layers (II) and (III) as the resin layers (A) may further contain a petroleum resin.

When the resin layer(s) (A) is at least one of the resin layer (I) and the resin layer (II), the resin layer(s) (A) may have a total thickness (total sum of thicknesses of all the resin layers (A)) not critical, but preferably equal to or more than 50%, more preferably equal to or more than 55%, and furthermore preferably equal to or more than 60%, based on the total thickness of the base layer part. The thickness within the range is preferred from the viewpoint of the shrink film transparency.

When the base layer part includes both the resin layer(s) (A) and the resin layer(s) (B), and the resin layer(s) (A) includes at least one of the resin layer (I) and the resin layer (II), the resin layer(s) (A) has a total thickness (total sum of thicknesses of all the resin layers (A)) of preferably, but not limitatively, larger than the total thickness of the resin layer(s) (B) (total sum of thicknesses of all the resin layers (B)). This is preferred from the viewpoint of the shrink film transparency.

The resin layer (A) may have a density not critical, but preferably 0.850 to 0.935 g/cm³, more preferably 0.870 to 0.925 g/cm³, and furthermore preferably 0.895 to 0.920 g/cm³. The resin layer (A), when having a density of equal to or more than 0.850 g/cm³, may advantageously allow the shrink label to have higher stiffness. In contrast, the resin layer (A), when having a density of equal to or less than 0.935 g/cm³, may advantageously allow the shrink label to have a lower specific gravity.

Resin Layer (B)

The resin layer (B) is not limited, as long as being a layer that contains a resin as an essential component and does not adversely affect the object of the present invention. The resin layer (B) is preferably a resin layer that is harder as compared with the resin layer (A). The base layer part, when including the resin layer (B) having this configuration, may allow the shrink film to have still higher stiffness. Examples of the resin contained in the resin layer (B) include, but are not limited to, polyolefin resins, amorphous cycloolefin polymers, ionomers, polyester resins, polystyrene resins, acrylic resins, urethane resins, vinyl chloride resins, and vinyl acetate resins. Among them, polyolefin resins, amorphous cycloolefin polymers, and ionomers are preferred. The resin layer (B) is preferably a resin layer containing at least one of an amorphous cycloolefin polymer and an ionomer.

Examples of the polyolefin resins, the amorphous cycloolefin polymers, and ionomers (namely, the polyolefin resins, amorphous cycloolefin polymers, and ionomers which may be contained in the resin layer (B)) include, but are not limited to, the polyolefin resins, amorphous cycloolefin polymers, and ionomers exemplified and described as the polyolefin resins, amorphous cycloolefin polymers, and ionomers to be contained in the resin layer (A).

When the resin layer (B) is a resin layer containing at least one of an amorphous cycloolefin polymer and an ionomer (specifically, a resin layer containing the component (C)), the resin layer (B) may have a total content of the amorphous cycloolefin polymer and the ionomer (namely, a content of the component (C)) not critical, but preferably equal to or more than 5 percent by weight, more preferably equal to or more than 10 percent by weight, and furthermore preferably equal to or more than 15 percent by weight, based on the total weight (100 percent by weight) of the resin layer (B). This is preferred from the viewpoint of higher stiffness. The upper limit of the content is not critical, but is preferably equal to or less than 100 percent by weight. When the resin layer (B) is a resin layer containing a polyolefin resin as a main component (specifically, a resin layer containing equal to or more than 50 percent by weight of a polyolefin resin), the content of the component (C) is not critical in terms of upper limit, but is preferably equal to or less than 45 percent by weight, and more preferably equal to or less than 40 percent by weight, based on the total weight (100 percent by weight) of the resin layer (B). This is preferred from the viewpoints of low specific gravity and higher stiffness.

The resin layer (B) may contain one or more additives within ranges not adversely affecting the advantageous effects of the present invention. Examples of the additives include, but are not limited to, lubricants, fillers, thermal stabilizers, antioxidants, ultraviolet absorbers, antistatic agents, anti-fogging agents, flame retardants, colorants, pinning agents (alkaline earth metals), and tackifiers. The resin layer (B) may contain recycled raw materials that are obtained by repelletizing film pieces formed upon film production.

Of the resin layers (B) having the configurations, the resin layer (B) is preferably selected from resin layers (i), (ii), (iii), (iv), and (v) as follows. The resin layer (i) is a resin layer (B) that contains an ionomer in a content of equal to or more than 50 percent by weight (preferably equal to or more than 80 percent by weight, and more preferably equal to or more than 90 percent by weight) based on the total weight (100 percent by weight) of the resin layer (B). The resin layer (ii) is a resin layer (B) that contains an amorphous cycloolefin polymer equal to or more than 50 percent by weight (preferably equal to or more than 80 percent by weight, more preferably equal to or more than 90 percent by weight) based on the total weight (100 percent by weight) of the resin layer (B). The resin layer (iii) is a resin layer (B) that contains an amorphous cycloolefin polymer and an LLDPE (preferably a metallocene-catalyzed LLDPE). The content of the amorphous cycloolefin polymer is 10 to 70 percent by weight (preferably 15 to 60 percent by weight, and more preferably 18 to 50 percent by weight) based on the total weight (100 percent by weight) of the resin layer (B). The content of the LLDPE is 30 to 90 percent by weight (preferably 40 to 85 percent by weight, and more preferably 50 to 82 percent by weight) based on the total weight (100 percent by weight) of the resin layer (B). The resin layer (iv) is a resin layer (B) that contains an amorphous cycloolefin polymer and a metallocene-catalyzed polypropylene (preferably a metallocene-catalyzed propylene-ethylene graft copolymer). The content of the amorphous cycloolefin polymer is 10 to 70 percent by weight (preferably 15 to 60 percent by weight, and more preferably 18 to 50 percent by weight) based on the total weight (100 percent by weight) of the resin layer (B). The content of the metallocene-catalyzed polypropylene is 30 to 90 percent by weight (preferably 40 to 85 percent by weight, and more preferably 50 to 82 percent by weight) based on the total weight (100 percent by weight) of the resin layer (B). The resin layer (v) is a resin layer (B) that contains an amorphous cycloolefin polymer, an LLDPE (preferably a metallocene-catalyzed LLDPE), and a metallocene-catalyzed polypropylene (preferably a metallocene-catalyzed propylene-ethylene graft copolymer). The content of the amorphous cycloolefin polymer is 10 to 70 percent by weight (preferably 15 to 60 percent by weight, and more preferably 18 to 50 percent by weight) based on the total weight (100 percent by weight) of the resin layer (B). The content of the LLDPE is 10 to 85 percent by weight (preferably 15 to 80 percent by weight, and more preferably 30 to 70 percent by weight) based on the total weight (100 percent by weight) of the resin layer (B). The content of the metallocene-catalyzed polypropylene is 1 to 80 percent by weight (preferably 2 to 70 percent by weight, and more preferably 5 to 50 percent by weight) based on the total weight (100 percent by weight) of the resin layer (B). The resin layers (iii) and (v) as the resin layers (B) may further include an LDPE.

The resin layer (B) may have a density not critical, but preferably 0.860 to 0.980 g/cm³, more preferably 0.875 to 0.960 g/cm³, and furthermore preferably 0.900 to 0.945 g/cm³. The resin layer (B), when having a density of equal to or more than 0.860 g/cm³, may advantageously allow the shrink label to have higher stiffness. In contrast, the resin layer (B), when having a density of equal to or less than 0.980 g/cm³, may advantageously allow the shrink label to have a lower specific gravity.

Combination of Resin Layer (A) and Resin Layer (B)

When the base layer part includes the resin layer (B), examples of preferred combinations of the resin layer (A) and the resin layer (B) include, but are not limited to, combinations in which the resin layer (A) is at least one selected from the resin layers (I), (II), and (III), and the resin layer (B) is at least one selected from the resin layers (i), (ii), (iii), (iv), and (v). Of the combinations, more preferred from the viewpoint of transparency are first, second, third, and fourth combinations as follows. In the first combination, the resin layer (A) is the resin layer (I), and the resin layer (B) is the resin layer (iii). In the second combination, the resin layer (A) is the resin layer (I), and the resin layer (B) is the resin layer (v). In the third combination, the resin layer (A) is the resin layer (II), and the resin layer (B) is the resin layer (iv). In the fourth combination, the resin layer (A) is the resin layer (II), and the resin layer (B) is the resin layer (v).

When the resin layer (B) is a resin layer that contains the component (C), the resin layer (B) may contain the component (C) in a content not critical, but preferably higher than the content of the component (C) in the resin layer (A). This is preferred from the viewpoint for the resin layer (B) to be harder as compared with the resin layer (A). In this case, the resin layer (A) may contain the component (C), or not. The content (in weight percent) of the component (C) in the resin layer (A) refers to a content based on the total weight (100 percent by weight) of the resin layer (A). The content (in weight percent) of the component (C) in the resin layer (B) refers to a content based on the total weight (100 percent by weight) of the resin layer (B). When the resin layer (A) and/or the resin layer (B) contains two or more different components (C), the “content of the component (C)” refers to the total sum of contents of all the components (C) contained in the resin layer (A) and/or the resin layer (B).

Assume that the resin layer (B) includes the component (C), and the resin layer (A) contains the component (C) in a content of 0 percent by weight. This case is also included in the cases where the resin layer (B) contains the component (C) in a content higher than the content of the component (C) in the resin layer (A). Specifically, examples of the cases where the resin layer (B) contains the component (C) in a content higher than the content of the component (C) in the resin layer (A) include, but are not limited to, the case in which the resin layer (A) does not contain the component (C), but the resin layer (B) contains the component (C); and the case in which both the resin layer (A) and the resin layer (B) contain the component (C), and the content of the component (C) in the resin layer (B) is higher than the content of the component (C) in the resin layer (A).

The difference between the total component (C) content in the resin layer (B) and the component (C) content in the resin layer (A) is not critical, but is preferably equal to or more than 5 percent by weight, more preferably equal to or more than 10 percent by weight, and furthermore preferably equal to or more than 15 percent by weight. This is preferred from the viewpoint of stability of the interface between the resin layer (A) and the resin layer (B). The difference is determined by subtracting the component (C) content in the resin layer (A) from the component (C) content in the resin layer (B).

When the resin layer (B) is a resin layer that contains a polyolefin resin, the polyolefin resin in the resin layer (B) preferably, but not limitatively, has a density of higher than the density of the polyolefin resin in the resin layer (A). This is preferred from the viewpoint of allowing the resin layer (B) to be harder as compared with the resin layer (A). The difference in density between the polyolefin resin in the resin layer (B) and the polyolefin resin in the resin layer (A) is preferably, but not limitatively, equal to or more than 0.005 g/cm³. The difference in density between the polyolefin resin in the resin layer (B) and the polyolefin resin in the resin layer (A) is preferably equal to or more than 0.005 g/cm³ particularly when the resin layer (B) is a resin layer that contains a polyolefin resin in a content of equal to or more than 50 percent by weight. The difference in density is preferably, but not limitatively, equal to or more than 0.005 g/cm³ particularly when the difference in polyolefin resin content between the resin layer (A) and the resin layer (B) is less than 20 percent by weight (and preferably less than 10 percent by weight).

The resin layer (B) preferably, but not limitatively, has a density higher than the density of the resin layer (A). This is preferred from the viewpoint of allowing the resin layer (B) to be harder as compared with the resin layer (A). The difference in density between the resin layer (B) and the resin layer (A) is preferably, but not limitatively, equal to or more than 0.005 g/cm³.

Among the combinations, particularly preferred illustrative embodiments of the combinations of the resin layer (A) and the resin layer (B) will be illustrated below. These are preferred for low specific gravity.

### First Illustrative Embodiment

A first illustrative embodiment illustrates a combination in which the resin layer (A) is a resin layer that contains a polyolefin resin in a content of equal to or more than 50 percent by weight and is devoid of, or approximately devoid of, components (C), and the resin layer (B) is a resin layer that contains a polyolefin resin in a content of equal to or more than 50 percent by weight and further contains a component (C).

The resin layer (A) according to the first illustrative embodiment contains the polyolefin resin in a content of equal to or more than 50 percent by weight (e.g., 50 to 100 percent by weight), and preferably 80 to 100 percent by weight, based on the total weight (100 percent by weight) of the resin layer (A).

The polyolefin resin in the resin layer (A) according to the first illustrative embodiment may have a density not critical, but preferably 0.850 to 0.935 g/cm³, more preferably 0.870 to 0.925 g/cm³, and furthermore preferably 0.895 to 0.920 g/cm³.

The resin layer (B) according to the first illustrative embodiment contains the polyolefin resin in a content of equal to or more than 50 percent by weight, preferably equal to or more than 55 percent by weight, and more preferably equal to or more than 60 percent by weight, based on the total weight (100 percent by weight) of the resin layer (B). The content in terms of upper limit may be less than 100 percent by weight and is preferably equal to or less than 95 percent by weight, and more preferably equal to or less than 90 percent by weight.

The resin layer (B) according to the first illustrative embodiment may contain the component (C) in a content not critical, but preferably equal to or less than 50 percent by weight (e.g., from more than 0 percent by weight to 50 percent by weight), more preferably 5 to 45 percent by weight, and furthermore preferably 10 to 40 percent by weight, based on the total weight (100 percent by weight) of the resin layer (B). The range is preferred for allowing the shrink label to have a low specific gravity.

The polyolefin resin in the resin layer (B) according to the first illustrative embodiment may have a density not critical, but preferably 0.850 to 0.935 g/cm³, more preferably 0.870 to 0.925 g/cm³, and furthermore preferably 0.895 to 0.920 g/cm³. When the resin layer (B) contains two or more different polyolefin resins, the density of the polyolefin resins is defined as the density of a mixture of all the polyolefin resins contained in the resin layer (B).

### Second Illustrative Embodiment

A second illustrative embodiment illustrates a combination in which both the resin layer (A) and the resin layer (B) are resin layers each independently containing a polyolefin resin in a content of equal to or more than 50 percent by weight, and both the resin layer (A) and the resin layer (B) further contain a component (C). The resin layer (B) contains the component (C) in a content higher than the content of the component (C) in the resin layer (A).

In the second illustrative embodiment, the resin layer (A) contains the polyolefin resin in a content of equal to or more than 50 percent by weight (e.g., from 50 percent by weight to less than 100 percent by weight), preferably 70 to 95 percent by weight, and more preferably 75 to 90 percent by weight, based on the total weight (100 percent by weight) of the resin layer (A).

The resin layer (A) according to the second illustrative embodiment may contain the component (C) in a content not critical, but preferably more than 0 percent by weight, more preferably equal to or more than 5 percent by weight, and furthermore preferably equal to or more than 10 percent by weight, based on the total weight (100 percent by weight) of the resin layer (A). The range is preferred for allowing the shrink label to have a low specific gravity. The content is not critical in terms of upper limit, but is preferably equal to or less than 50 percent by weight, more preferably equal to or less than 30 percent by weight, and furthermore preferably equal to or less than 25 percent by weight.

The polyolefin resin in the resin layer (A) according to the second illustrative embodiment may have a density not critical, but preferably 0.850 to 0.935 g/cm³, more preferably 0.870 to 0.925 g/cm³, and furthermore preferably 0.895 to 0.920 g/cm³.

The resin layer (B) according to the second illustrative embodiment contains the polyolefin resin in a content of equal to or more than 50 percent by weight (e.g., from 50 percent by weight to less than 100 percent by weight), and preferably 55 to 90 percent by weight, based on the total weight (100 percent by weight) of the resin layer (B).

The resin layer (B) according to the second illustrative embodiment may contain the component (C) in a content not critical, but preferably more than 5 percent by weight, more preferably equal to or more than 10 percent by weight, and furthermore preferably equal to or more than 15 percent by weight, based on the total weight (100 percent by weight) of the resin layer (B). The content is not critical in terms of upper limit, but is preferably equal to or less than 50 percent by weight, more preferably equal to or less than 45 percent by weight, and furthermore preferably equal to or less than 40 percent by weight.

The polyolefin resin in the resin layer (B) according to the second illustrative embodiment may have a density not critical, but preferably 0.850 to 0.935 g/cm³, more preferably 0.870 to 0.925 g/cm³, and furthermore preferably 0.895 to 0.920 g/cm³.

In the second illustrative embodiment, the difference in component (C) content between the resin layer (B) and the resin layer (A) is not critical, but preferably equal to or more than 5 percent by weight, more preferably equal to or more than 10 percent by weight, and furthermore preferably equal to or more than 15 percent by weight. This is preferred for allowing the resin layer (A) and the resin layer (B) to have a large difference in density from each other. The difference is determined by subtracting the component (C) content in the resin layer (A) from the component (C) content in the resin layer (B).

### Third Illustrative Embodiment

A third illustrative embodiment illustrates a combination in which the resin layer (A) and the resin layer (B) each independently contain a polyolefin resin in a content of equal to or more than 50 percent by weight. The difference in polyolefin resin content between the resin layer (A) and the resin layer (B) is less than 20 percent by weight (and preferably less than 10 percent by weight). The polyolefin resin in the resin layer (B) has a density higher than the density of the polyolefin resin in the resin layer (A).

In the third illustrative embodiment, the resin layer (A) contains the polyolefin resin in a content of equal to or more than 50 percent by weight, preferably equal to or more than 70 percent by weight, and more preferably equal to or more than 75 percent by weight, based on the total weight (100 percent by weight) of the resin layer (A). The content is not critical in terms of upper limit, but is preferably equal to or less than 100 percent by weight, more preferably equal to or less than 95 percent by weight, and furthermore preferably equal to or less than 90 percent by weight.

The resin layer (A) according to the third illustrative embodiment may contain a component (C). When the resin layer (A) according to the third illustrative embodiment contains the component (C), the resin layer (A) may contain the component (C) in a content not critical, but preferably equal to or less than 50 percent by weight (e.g., 0 to 50 percent by weight), more preferably 5 to 30 percent by weight, and furthermore preferably 10 to 25 percent by weight, based on the total weight (100 percent by weight) of the resin layer (A). This is preferred for allowing the shrink label to have a low specific gravity.

The polyolefin resin in the resin layer (A) according to the third illustrative embodiment may have a density not critical, but preferably 0.850 to 0.935 g/cm³, more preferably 0.870 to 0.925 g/cm³, and furthermore preferably 0.890 to 0.920 g/cm³.

The resin layer (B) according to the third illustrative embodiment contains the polyolefin resin in a content of equal to or more than 50 percent by weight, preferably equal to or more than 70 percent by weight, and more preferably equal to or more than 75 percent by weight, based on the total weight (100 percent by weight) of the resin layer (B). The content is not critical in terms of upper limit, but is preferably equal to or less than 100 percent by weight, more preferably equal to or less than 95 percent by weight, and furthermore preferably equal to or less than 90 percent by weight.

The resin layer (B) according to the third illustrative embodiment may contain a component (C). When the resin layer (B) according to the third illustrative embodiment contains the component (C), the resin layer (B) may contain the component (C) in a content not critical, but preferably equal to or less than 50 percent by weight (e.g., 0 to 50 percent by weight), more preferably 5 to 30 percent by weight, and furthermore preferably 10 to 25 percent by weight, based on the total weight (100 percent by weight) of the resin layer (B). This is preferred for allowing the shrink label to have a low specific gravity.

The polyolefin resin in the resin layer (B) according to the third illustrative embodiment may have a density not critical, but preferably 0.850 to 0.935 g/cm³, more preferably 0.870 to 0.930 g/cm³, and furthermore preferably 0.895 to 0.925 g/cm³.

In the third illustrative embodiment, the difference in density between the polyolefin resin in the resin layer (B) and the polyolefin resin in the resin layer (A) is preferably, but not limitatively, equal to or more than 0.005 g/cm³.

### Fourth Illustrative Embodiment

A fourth illustrative embodiment illustrates a combination in which the resin layer (A) is a resin layer that contains a polyolefin resin (preferably, a polyethylene resin) in a content of equal to or more than 90 percent by weight, and the resin layer (B) is a resin layer that contains a component (C) in a content of equal to or more than 55 percent by weight.

In the fourth illustrative embodiment, the resin layer (A) contains the polyolefin resin (preferably, the polyethylene resin) in a content of equal to or more than 90 percent by weight (e.g., 90 to 100 percent by weight), and preferably 95 to 100 percent by weight, based on the total weight (100 percent by weight) of the resin layer (A).

The resin layer (B) according to the fourth illustrative embodiment may contain the component (C) in a content of preferably equal to or more than 55 percent by weight, more preferably equal to or more than 65 percent by weight, and furthermore preferably equal to or more than 70 percent by weight, based on the total weight (100 percent by weight) of the resin layer (B). The content is not critical in terms of upper limit, but is preferably less than 100 percent by weight, more preferably equal to or less than 95 percent by weight, and furthermore preferably equal to or less than 90 percent by weight.

The resin layer (B) according to the fourth illustrative embodiment may contain a polyolefin resin. When the resin layer (B) according to the fourth illustrative embodiment contains a polyolefin resin, the resin layer (B) may contain the polyolefin resin in a content not critical, but preferably from more than 0 percent by weight to less than 50 percent by weight, more preferably 5 to 45 percent by weight, and furthermore preferably 10 to 35 percent by weight, based on the total weight (100 percent by weight) of the resin layer (B).

The polyolefin resin in the resin layers (A) according to the fourth illustrative embodiment may have a density not critical, but preferably 0.850 to 0.935 g/cm³, more preferably 0.870 to 0.930 g/cm³, furthermore preferably 0.895 to 0.925 g/cm³, and particularly preferably 0.898 to 0.920 g/cm³.

Layer Configuration, Properties, and Any Other Factors of Base Layer Part

The base layer part includes layers in a number of 5 to 65, and preferably 9 to 33. Assume that the base layer part includes layers in a number of less than 5. This configuration may cause the shrink label to less effectively have higher stiffness, where such effects to offer higher stiffness are given by lamination of multiple layers to form the base layer part. The configuration (lamination of layers in an insufficient number) may also cause the shrink label to have low hardness and to less effectively have better stretchability. The lamination of layers in an insufficient number may fail to allow the resin layer (A) and/or the resin layer (B) to have a sufficiently small thickness (thickness per layer). This may cause the shrink label to have lower transparency. In contrast, assume that the base layer part includes layers in a number of more than 65; and that the shrink film is controlled to have a thickness (total thickness) within such a range as to be suitable as a shrink label. In this case, the resin layers (A) (and/or the resin layers (B)) may have an excessively small thickness (thickness per layer). The resin layers (A) (and/or the resin layers (B)) having such an excessively small thickness may impart less effects to the shrink film and the shrink label and may cause the shrink film and the shrink label to have lower stiffness and to have lower hardness. The resin layers (A) (and/or the resin layers (B)) having such an excessively small thickness may also cause the shrink film to have low transparency.

The layers constituting the base layer part include the resin layer (A) in a number of equal to or more than 1, preferably equal to or more than 2, and more preferably equal to or more than 4. The number of the resin layer (A) is not critical in terms of upper limit, as long as being equal to or less than 65, but is preferably equal to or less than 33, and more preferably equal to or less than 17.

Though not limited, the layers constituting the base layer part may include the resin layer (B) in a number of preferably equal to or more than 1, more preferably equal to or more than 2, and furthermore preferably equal to or more than 4. The number of the resin layer (B) is not critical in terms of upper limit, as long as being equal to or less than 64, but is preferably equal to or less than 33, and more preferably equal to or less than 17.

When the base layer part includes one or more resin layers (B), the base layer part preferably, but not limitatively, has a multilayer configuration in which the resin layer (A) and the resin layer (B) are adjacent to each other.

When the base layer part includes one or more resin layers (B), the one or more resin layers (B) in the base layer part are preferably, but not limitatively, disposed between two or more resin layers (A), and more preferably disposed between all pairs of resin layers (A) in the base layer part. In this case, the base layer part has a multilayer configuration including a unit of [resin layer (A)/resin layer (B)/resin layer (A)] and has two or more interfaces each formed between an adjacent pair of the resin layer (A) and the resin layer (B). In particular, the resin layer (A) and the resin layer (B) in the base layer part are preferably, but not limitatively, disposed on each other in alternate order, and more preferably disposed directly on each other in alternate order without the medium of any other layer. Specifically, the layers constituting the base layer part most preferably include the resin layers (A) and the resin layers (B) in alternate order in a total number of 5 to 65.

When the base layer part includes one or more resin layers (B), the number of the resin layers (A) and the number of the resin layers (B) in the base layer part are not critical, but are each preferably 2 to 33, and more preferably 4 to 17.

When the base layer part includes one or more resin layers (B), the base layer part preferably has an interface in a number of preferably, but not limitatively, equal to or more than 2, more preferably equal to or more than 3, and furthermore preferably equal to or more than 4, where the interface is formed between an adjacent (directly stacked) pair of the resin layer (A) and the resin layer (B). The upper limit of the interface number is 64, preferably 33, and more preferably 17. The base layer part, when having two or more of the interface, may advantageously allow the shrink film to have higher stiffness in spite of having a low specific gravity.

The base layer part has only to include at least one resin layer (A). When the base layer part is constituted by resin layers (A) and resin layers (B) alone, the multilayer configuration of the base layer part is specifically preferably, but not limitatively, a multilayer configuration in which a constitutional repeating unit of “resin layer (A)/resin layer (B)” is repeated. Specifically, examples of the multilayer configuration include, but are not limited to, [resin layer (A)/resin layer (B)/resin layer (A)/resin layer (B)/ . . . /resin layer (A)/resin layer (B)/resin layer (A)]; [resin layer (B)/resin layer (A)/resin layer (B)/resin layer (A)/ . . . /resin layer (B)/resin layer (A)/resin layer (B)]; [resin layer (A)/resin layer (B)/resin layer (A)/resin layer (B)/ . . . /resin layer (A)/resin layer (B)]; and [resin layer (B)/resin layer (A)/resin layer (B)/resin layer (A)/ . . . /resin layer (B)/resin layer (A)]. The outermost layers on both sides of the base layer part may be either one or both of the resin layer (A) and the resin layer (B). The multilayer configuration may further include the layer E between one or more pairs of the layers.

In the base layer part, all the resin layers (A) are preferably, but not limitatively, made from an identical material; and all the resin layers (B) are preferably, but not limitatively, made from an identical material. Specifically, the resin layers (A) are preferably made from a material identical to each other; and the resin layers (B) are preferably formed from a material identical to each other. In particular, it is preferred that all the resin layers (A) are layers having an identical composition; and all the resin layers (B) are layers having an identical composition.

The base layer part may contain a polyolefin resin in a content not critical, but preferably equal to or more than 50 percent by weight, more preferably equal to or more than 60 percent by weight, and furthermore preferably equal to or more than 70 percent by weight, based on the total weight (100 percent by weight) of the base layer part. The content is not critical in terms of upper limit, but may be 100 percent by weight.

Configuration, Properties, and Any Other Factors of Shrink Film in Present Invention

The shrink film in the present invention includes the base layer part and the two surface layers. Specifically, the surface layers are respectively disposed on or over the both sides of the base layer part, namely, one of the surface layers is disposed on or over one side of the base layer part, and the other surface layer is disposed on or over the other side of the base layer part.

The shrink film in the present invention may have a thickness (total thickness) not critical, but preferably 10 to 100 μm, more preferably 15 to 50 μm, and furthermore preferably 20 to 45 μm. The shrink film, when having a total thickness of equal to or more than 10 μm, may advantageously allow the shrink label to have higher stiffness sufficiently effectively.

The surface layers may each have a thickness (thickness per layer) not critical, but preferably 1 to 15 μm, more preferably 2 to 10 μm, and furthermore preferably 2.5 to 8 μm. The surface layers, when having a thickness per layer of equal to or more than 1 μm, may advantageously more readily allow the shrink label to have higher stiffness effectively. The surface layers, when having a thickness per layer of equal to or less than 15 μm, may advantageously eliminate or minimize remarkable reduction of elongation of the shrink film at room temperature. The surface layers respectively in the both sides of the shrink film in the present invention may have thicknesses identical to, or different from, each other.

The base layer part may have a thickness not critical, but preferably 8 to 90 μm, more preferably 10 to 45 μm, and furthermore preferably 11 to 40 μm. The base layer part, when having a thickness of equal to or more than 8 μm, may advantageously allow the shrink label to have stiffness within a more appropriate range.

The resin layer(s) (A) may have a thickness (thickness per layer) not critical, but preferably equal to or more than 0.3 μm (e.g., 0.3 to 15 μm), and more preferably equal to or more than 0.5 μm (e.g., 0.5 to 10 μm). The resin layer(s) (A), when having a thickness per layer of equal to or more than 0.3 μm, may advantageously allow the shrink label to have higher stiffness sufficiently effectively. When the shrink film in the present invention includes two or more resin layers (A), all or part of the two or more resin layers (A) in the shrink film in the present invention may have thicknesses identical to, or different from, each other. For example, a resin layer (A) that resides in the base layer part and is in contact with the surface layer may have a smaller thickness as compared with another resin layer (A) that resides in the base layer part, but is not in contact with the surface layer. A not-limiting example of the resin layer (A) that resides in the base layer part and is not in contact with the surface layer is a resin layer (A) disposed between two resin layers (B). Specifically, the resin layer (A) that resides in the base layer part and is in contact with the surface layer may have a thickness (thickness per layer) not critical, but preferably equal to or more than 0.2 μm (e.g., 0.2 to 10 μm), and more preferably equal to or more than 0.3 μm (e.g., 0.3 to 5 μm).

When the base layer part includes one or more resin layers (B), the resin layer(s) (B) may have a thickness (thickness per layer) not critical, but preferably equal to or more than 0.3 μm (e.g., 0.3 to 15 μm), and more preferably equal to or more than 0.5 μm (e.g., 0.5 to 10 μm). The resin layer(s) (B), when having a thickness per layer of equal to or more than 0.3 μm, may advantageously allow the shrink label to have higher stiffness sufficiently effectively. When the shrink film in the present invention includes two or more resin layers (B), all or part of the two or more resin layers (B) in the shrink film in the present invention may have thicknesses identical to, or different from, each other. For example, a resin layer (B) that resides in the base layer part and is in contact with the surface layer may have a smaller thickness as compared with another resin layer (B) that resides in the base layer part, but is not in contact with the surface layer. A not-limiting example of the resin layer (B) that resides in the base layer part and is in contact with the surface layer is a resin layer (B) disposed between two resin layers (A). Specifically, the resin layer (B) that resides in the base layer part and is in contact with the surface layer may have a thickness (thickness per layer) not critical, but preferably equal to or more than 0.2 μm (e.g., 0.2 to 10 μm), and more preferably equal to or more than 0.3 μm (e.g., 0.3 to 5 μm).

In the shrink film in the present invention, the ratio of the total thickness of the surface layers (total thickness of the two surface layers) to the thickness of the base part is not critical, but preferably from 1:14 to 1:1, more preferably from 1:8 to 1:1, and particularly preferably from 1:4 to 1:1. When the base layer part has a thickness equal to or more than the total thickness of the surface layers (when the ratio is equal to or less than 1:1), the multilayer lamination of the base layer part may advantageously more readily develop effects of allowing the shrink film to have higher stiffness and better transparency. When the surface layers have a total thickness equal to or more than one-fourteenth the thickness of the base layer part (when the ratio is equal to or more than than 1:14), the surface layers may advantageously allow the shrink label to have higher stiffness more sufficiently effectively.

In a non-limiting exemplary configuration, the layers constituting the base layer part include resin layers (A) and resin layers (B) in alternate order in a total number of 5 to 65; and outermost resin layers of the base layer part on which the surface layers are to be disposed are resin layers (A). In this configuration, the ratio of the thickness of the resin layers (A) (the total thickness of all the resin layers (A)) to the thickness of the resin layers (B) (the total thickness of all the resin layers (B)) is not critical, but is preferably from 1:10 to 10:1, more preferably from 1:8 to 5:1, and particularly preferably from 1:5 to 1:1. This is preferred from the viewpoints of low specific gravity and improvements in transparency, heat shrinkability, stretchability, and stiffness.

The shrink film in the present invention is preferably an oriented film, where the orientation is exemplified by uniaxial, biaxial, and multiaxial orientations. This configuration is preferred from the viewpoint of exhibiting shrinkage properties. More preferably, all film layers (surface layers, resin layers (A), and resin layers (B)) constituting the shrink film are preferably oriented films, where the orientation is exemplified by uniaxial, biaxial, and multiaxial orientations. In particular, the shrink film is often selected from uniaxially-oriented films and biaxially-oriented films. Among them, the shrink film is generally selected from films that are highly oriented in one axial direction of the film (approximately uniaxially stretched films). In particular, the shrink film is preferably selected from films that are uniaxially stretched in the transverse direction (width direction).

The shrink film in the present invention (before shrink processing) may have a heat shrinkage percentage (90° C., 10 sec.) in a main orientation direction of not critical, but preferably equal to or more than 45% (e.g., 45% to 80%). The “heat shrinkage percentage (90° C., 10 sec.)” refers to a heat shrinkage percentage in a hot water treatment at 90° C. for 10 seconds. The shrink film, when having a heat shrinkage percentage (90° C., 10 sec.) of equal to or more than 45%, may allow the shrink label to shrink sufficiently in a shrinking step, in which heat is applied to the shrink label to allow the shrink label to shrink and to be intimate contact with a container. This configuration may advantageously eliminate or minimize insufficient conformity of the shrink label to the container and, in particular, may eliminate or minimize the deterioration in finished quality to a container that has a complicated shape. The term “main orientation direction” refers to a direction in which the stretching is mainly performed (a direction in which the shrink film has a highest heat shrinkage percentage). In general, the main orientation direction may be a machine direction (longitudinal direction) or a transverse direction. For example, when the shrink film is a film that is approximately uniaxially stretched in the transverse direction (approximately transversely uniaxially-oriented film), the main orientation direction is the transverse direction.

The shrink film in the present invention (before shrink processing) may have a heat shrinkage percentage (90° C., 10 sec.) in a direction perpendicular to the main orientation direction of not critical, but preferably −5% to 10%.

The shrink film in the present invention may have a haze of preferably less than 10%, more preferably less than 7%, and furthermore preferably equal to or less than 6%. The “haze” is determined in conformity to JIS K 7136, in terms of 40 μm thickness and is indicated in percentage (%). Assume that the shrink film has a haze of equal to or more than 10%; and that this shrink film is used in a shrink label in which a print is applied to an inner side of the shrink film, and the print is to be seen through the shrink film, where the inner side is a side to face a container when the label is attached to the container. In this case, when the shrink label is processed into a product (as attached to the container), the print may look hazed and the shrink label may offer inferior decorativeness. However, the shrink film, even if having a haze of equal to or more than 10%, is sufficiently usable in other applications than the above one in which the print is to be seen through the shrink film.

The shrink film in the present invention may have a density not critical, but preferably less than 1 g/cm³ (e.g., from 0.90 g/cm³ to less than 1 g/cm³), more preferably equal to or less than 0.97 g/cm³, and furthermore preferably equal to or less than 0.95 g/cm³. This is preferred from the viewpoint of allowing the shrink label to have a low specific gravity.

### Shrink Label

The shrink label according to the present invention includes the shrink film in the present invention. The shrink label according to the present invention may further include one or more layers other than the shrink film in the present invention.

Other Layers than Shrink Film in Present Invention

The shrink label according to the present invention may include one or more other layers than the shrink film in the present invention. Examples of the other layers include, but are not limited to, print layer; other film layers such as nonwoven fabrics and foamed sheets; pressure-sensitive adhesive layers, heat-sensitive adhesive layers, and any other adhesive layers for the adhesion (bonding) with a target adherend of the shrink label or with another film layer; protective layers; anchor coat layers; primer coating layers; coating layers; antistatic layers; and vapor-deposited aluminum layers.

Print Layer

The print layer is not limited and may be selected from known print layers for use in shrink labels. Examples of the print layer include, but are not limited to, designed print layers (e.g., color print layers) and background print layers. The designed print layers illustrate figures and designs typically of trade names, illustrations, and handling precautions. The background print layers are indicated by a single color such as white. Though not limited, the print layer may be disposed on either one or both sides of the shrink film in the present invention. The print layer may be disposed entirely or partially on a surface (the surface on which the print layer is to be disposed) of the shrink film in the present invention. Though not limited, the print layer may be a single layer or multilayer.

The print layer preferably, but not limitatively, contains a binder resin as an essential component. The print layer preferably further contains a coloring pigment as needed. Examples of the coloring pigments include, but are not limited to, blue, red, yellow, black, and white pigments. The print layer may contain each of different binder resins alone or in combination and may contain each of different coloring pigments alone or in combination.

The binder resins are not limited and may be selected from resins for use as binder resins in known print layers and printing inks. Examples of the binder resins include, but are not limited to, acrylic resins, urethane resins, polyester resins, polyamide resins, cellulose resins (including nitrocellulose resins), and vinyl chloride-vinyl acetate copolymer resins. Examples of the coloring pigments include, but are not limited to, coloring pigments for use in known print layers and printing inks. The coloring pigments may be selected and used according to the intended use. Examples of the coloring pigments include, but are not limited to, white pigments such as titanium dioxide; cyan pigments such as copper phthalocyanine blue; and other coloring pigments such as carbon black, aluminum flake, and mica. Examples of the coloring pigments further include extender pigments such as alumina, calcium carbonate, barium sulfate, silica, and acrylic beads. The extender pigments may be used for gloss adjustment and any other purposes.

The print layer may have a thickness not critical, but typically preferably 0.1 to 10 μm, and more preferably 0.3 to 5 μm. The print layer, if having a thickness of less than 0.1 μm, may be difficult to be provided uniformly. The nonuniform print layer may suffer from partial “blur (poor print quality)” and may cause the shrink label to have inferior decorativeness. In addition, the nonuniform print layer may fail to be printed as designed. In contrast, the print layer, if having a thickness of more than 10 μm, may consume a large amount of the printing ink and may increase the cost. The excessively thick print layer may fail to be formed uniformly by coating and/or may become brittle and become susceptible to peeling off. The excessively thick print layer may less follow the thermal shrinkage of the shrink film upon shrink processing.

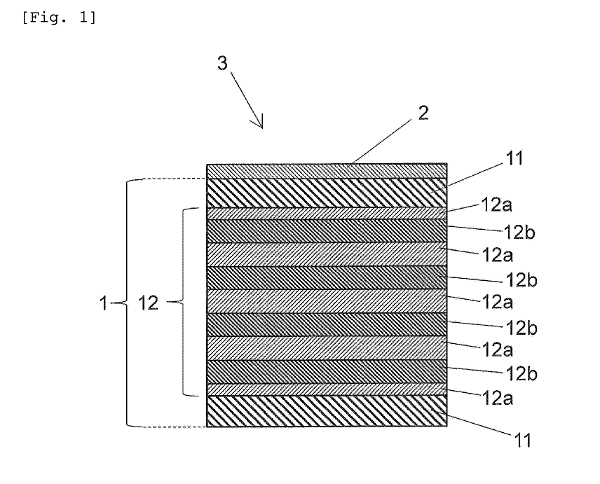

FIGS. 1 to 4 are schematic views (local sectional views) of embodiments of shrink labels according to the present invention. The shrink label 3 according to the present invention illustrated in FIG. 1 includes a shrink film 1 in the present invention and a print layer 2. The print layer 2 is disposed on one side of the shrink film 1 in the present invention. The shrink film 1 in the present invention includes a base layer part 12 and surface layers 11. The surface layers are respectively disposed on both sides of the base layer part 12 (one surface layer per side). Resin layers (A) 12a constitute outermost layers of the base layer part 12. The outermost layers are layers in contact with the surface layers 11. The base layer part 12 is constituted by resin layers (A) 12a and resin layers (B) 12b disposed on each other in alternate order in a total number of 9. The surface layers 11 are disposed directly on the base layer part 12 without the medium of any other layer. Specifically, the surface layers 11 are disposed directly, without the medium of any other layer, on the resin layers (A) 12a that constitute the outermost layers of the base layer part 12.

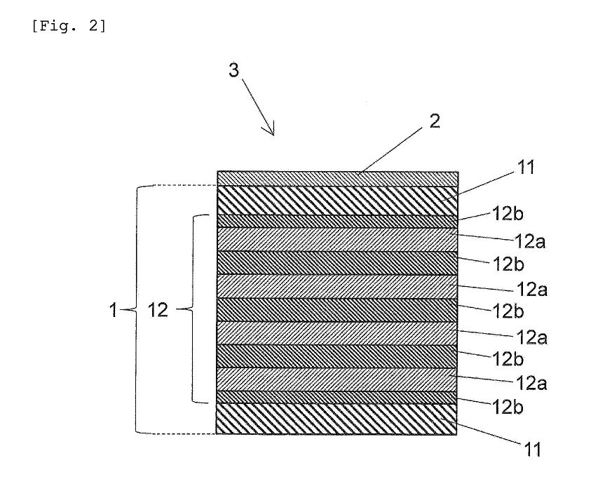

The shrink label 3 according to the present invention illustrated in FIG. 2 includes a shrink film 1 in the present invention and a print layer 2. The print layer 2 is disposed on one side of the shrink film 1 in the present invention. The shrink film 1 in the present invention includes a base layer part 12 and surface layers 11. The surface layers 11 are disposed on both sides of the base layer part 12 (one surface layer per side). The shrink label 3 according to the present invention illustrated in FIG. 2 corresponds to the shrink label illustrated in FIG. 1, except for having an inverse relationship in terms of location between the resin layers (A) 12a and the resin layers (B) 12b in the base layer part 12. Specifically, resin layers (B) 12b constitute outermost layers of the base layer part 12. The outermost layers are layers in contact with the surface layers 11. The base layer part 12 is constituted by resin layers (A) 12a and resin layers (B) 12b disposed on each other in alternate order in a total number of 9. The surface layers 11 are disposed directly on the base layer part 12 without the medium of any other layer. Specifically, the surface layers 11 are disposed directly, without the medium of any other layer, on the resin layers (B) 12b that constitute the outermost layers of the base layer part 12.

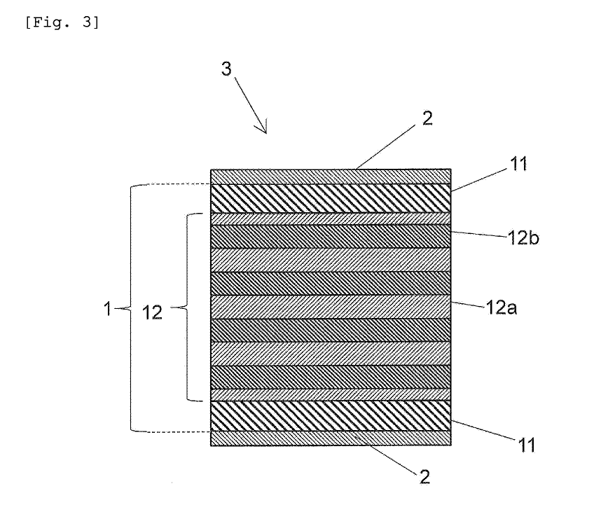

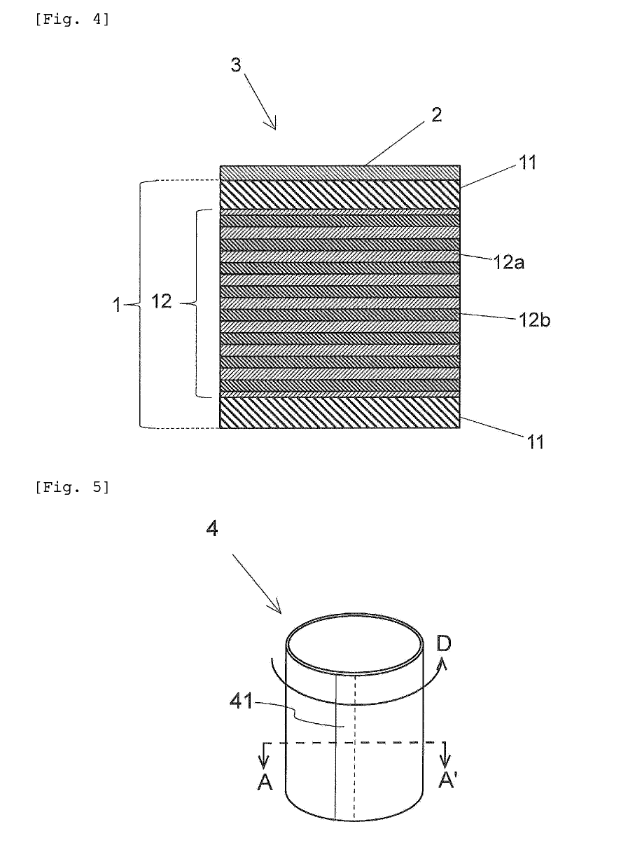

The shrink label 3 according to the present invention illustrated in FIG. 3 includes a shrink film 1 in the present invention and print layers 2. The shrink film 1 is as in the shrink label illustrated in FIG. 1. The print layers 2 are disposed on both sides of the shrink film 1 in the present invention. The shrink label 3 according to the present invention illustrated in FIG. 4 includes a shrink film 1 in the present invention and a print layer 2. The print layer 2 is disposed on one side of the shrink film 1 in the present invention. The shrink film 1 in the present invention includes surface layers 11 and a base layer part 12. Resin layers (A) 12a constitute the outermost layers of the base layer part 12. The outermost layers are layers in contact with the surface layers 11. The base layer part 12 is constituted by resin layers (A) 12a and resin layers (B) 12b disposed on each other in alternate order in a total number of 17. Also in the shrink label illustrated in FIG. 4, the surface layers 11 are disposed directly on the base layer part 12 without the medium of any other layer. Specifically, the surface layers 11 are disposed directly, without the medium of any other layer, on the resin layers (A) 12a that constitute the outermost layers of the base layer part 12. The shrink labels 3 according to the present invention illustrated in FIGS. 3 and 4, may have an inverse relationship in terms of location between the resin layers (A) 12a and the resin layers (B) 12b.

The shrink label according to the present invention may have a thickness (total thickness) not critical, but preferably 10 to 110 μm, more preferably 15 to 60 μm, and furthermore preferably 20 to 50 μm. The shrink label according to the present invention, when having a thickness of equal to or more than 10 μm, may advantageously have higher stiffness sufficiently effectively.

The shrink label according to the present invention may have a density not critical, but preferably less than 1 g/cm³, more preferably less than 0.99 g/cm³, and furthermore preferably less than 0.98 g/cm³. This is preferred from the viewpoint of allowing the shrink label to have a low specific gravity. The density may be typically equal to or more than 0.92 g/cm³ in terms of lower limit.

Examples of forms upon use of the shrink label according to the present invention include, but are not limited to, a shrink sleeve label and a roll-on shrink sleeve label. In the shrink sleeve label, both ends of the label is sealed with each other with a solvent and/or an adhesive to form a sleeve label, and the sleeve label is attached to a container. In the roll-on shrink sleeve label, one end of the label is applied to a container, the label is wound around the container, and the other end of the label is overlapped with the one end to form a cylindrical label. The shrink film in the present invention has excellent seaming ability upon application of a shrink sleeve label to a container. This configuration allows the shrink film to be advantageously used to form the shrink sleeve label. Specifically, the shrink label according to the present invention is preferably a shrink sleeve label.

The shrink sleeve label is preferably a shrink sleeve label as follows. This shrink sleeve label is a shrink label that includes a background print layer, a designed print layer, and the shrink film in the present invention disposed in this order and is present in sleeve form, in which the background print layer faces inward in the shrink sleeve label, and the shrink sleeve label has both ends overlapped with each other at a seam (center-sealed portion). This shrink sleeve label is hereinafter also referred to as a “shrink sleeve label according to the present invention”. The shrink film in the present invention in the shrink sleeve label according to the present invention is preferably oriented at least in a circumferential direction of the shrink sleeve label. The seam is preferably bonded with a solvent or an adhesive. In the shrink sleeve label according to the present invention, two ends (two portions) of the shrink film in the present invention are preferably bonded to each other with a solvent or an adhesive at the seam. This configuration is preferred from the viewpoint of adhesiveness of the seam. The bonding of the two portions of the shrink film in the present invention to each other at the seam may be achieved typically in the following manner. Neither background print layer nor designed print layer is provided in a portion (in one end of the shrink label) to be bonded to the other portion of the shrink film with a solvent or an adhesive at the seam to allow a surface of the shrink film to be exposed. The exposed surface of the shrink film is bonded to an exposed surface of the shrink film in the other end of the shrink label. In particular, the shrink sleeve label preferably has a seam that is constituted by two ends of the shrink film in the present invention, where the two ends are bonded to each other with a solvent in a portion where neither background print layer nor designed print layer is provided. In the both ends, portions that are not to be bonded may bear the background print layer and/or the designed print layer since the presence of print layers and any other layers does not affect the adhesiveness in these portions.

Examples of the designed print layer include, but are not limited to, layers indicating one or more indications such as trade names, illustrations, and handling precautions. Example of the designed print layer include, but are not limited to, the print layers. More specifically, the designed print layer may be constituted by two or more print layers containing two or more different coloring pigments so as to provide a desired design.

The designed print layer may have a thickness not critical, but preferably 0.1 to 8 μm.

The background print layer is a print layer that constitutes a background to the designed print layer when the shrink sleeve label according to the present invention is observed from outside of the sleeve. Examples of the background print layer include, but are not limited to, the print layers. Among them, examples of preferred background print layers include white print layers each containing titanium oxide. The titanium oxide is a coloring pigment.

The background print layer may have a thickness not critical, but preferably 0.5 to 10 μm.

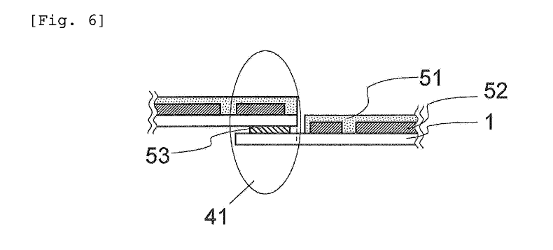

FIGS. 5 and 6 are schematic views of a shrink sleeve label according to an embodiment of the present invention. The shrink sleeve label is a shrink label according to the present invention. The shrink sleeve label 4 according to the present invention illustrated in FIG. 5 is in sleeve form, in which one end of a rectangular shrink label according to the present invention is overlapped with the outer surface of the other end, and the outer surface of the other end and the inner surface of the one end are bonded to each other with a solvent or an adhesive at a seam 41. The shrink label according to the present invention includes the shrink film in the present invention. The shrink film in the present invention is oriented at least in the circumferential direction D of the shrink sleeve label. The shrink film is thermally shrinkable in the circumferential direction D. The shrink film in the present invention is preferably applied so that the circumferential direction is the main orientation direction.

FIG. 6 is an enlarged view of the essential parts of a cross section taken along the line A-A′ in FIG. 5. At the seam 41, both ends of the shrink label are bonded to each other with a solvent or adhesive 53. Specifically, the shrink label according to the present invention includes a background print layer 51, a designed print layer 52, and the shrink film 1 in the present invention disposed in this order. The designed print layer 52 and the background print layer 51 are disposed on or over the shrink film 1, excluding a region with a predetermined width from an extremity of the one end of the shrink film in the present invention in a side (a side constituting the inner side of the sleeve at the seam). The designed print layer 52 and the background print layer 51 are not disposed in the region with a predetermined width from the extremity of the one end of the shrink label according to the present invention. In the region, the shrink film in the present invention is exposed to be a film-exposed surface. At the seam 41, the film-exposed surface disposed in the inner surface of the one end of the shrink label according to the present invention is bonded to the outer surface (film-exposed surface) of the other end with the solvent or adhesive 53.

The shrink film in the present invention for use in the shrink label according to the present invention includes the base layer part and the surface layers. The surface layers are respectively disposed on both sides of the base layer part. The surface layers each contain an amorphous cycloolefin polymer. The amorphous cycloolefin polymer is a principal component. The base layer part includes 5 to 65 layers that include at least one resin layer (A). The resin layer (A) contains a polyolefin resin. The polyolefin resin is a principal component. Since the shrink film (and the shrink label) have this configuration, the shrink film and the shrink label have excellent stiffness and high hardness even though having a small thickness. The shrink film in the present invention has the multilayers structure. This configuration may allow the shrink film (and the shrink label) to have excellent stretchability such as resistance to rupture and resistance to natural contraction after stretching and to have a low specific gravity. The shrink film and the shrink label also have excellent heat shrinkability and satisfactory transparency.

### Method According to Present Invention for Producing Shrink Label

A method according to the present invention for producing a shrink label includes the step of preparing a shrink film in the present invention. The “step of preparing a shrink film in the present invention” is also referred to as a “film preparation step” in the present description. The method according to the present invention for producing a shrink label may further include one or more other steps in addition to the film preparation step. A non-limiting example of the other steps is the step of forming another layer than the shrink film in the present invention.

Film Preparation Step

In the film preparation step, the shrink film in the present invention may be prepared by any of common techniques such as melt film forming techniques. Among them, melt film forming techniques are preferred, of which T-die technique is particularly preferred. Examples of lamination techniques include, but are not limited to, common techniques including coextrusion techniques such as feedblock technique and multi-manifold technique; and dry lamination techniques. Among them, coextrusion techniques are preferred, of which feedblock technique is more preferred. The lamination to form the base layer part is preferably performed using a layer multiplier and particularly preferably performed using the layer multiplier in combination with one or more feedblocks. The layer multiplier is an apparatus that laminates film layers to form a multilayer assembly. A non-limiting example of the lamination technique of film layers using the layer multiplier is a technique of dividing a film layer in the transverse direction, and stacking the divided film layers in the thickness direction. The “layer multiplier” is also simply referred to as a “multiplier”. The multiplier is available typically from Nordson Extrusion Dies Industries, LLC. and from Cloeren Incorporated.

A specific example (feedblock technique) of the coextrusion techniques will be illustrated below. Typically, a material or materials to form the base layer part and a material or materials to form the surface layers are independently placed into two or more extruders individually set at predetermined temperatures. The materials are then coextruded from T-dies. In this process, multiple layers are stacked to form a base layer part having a predetermined multilayer configuration preferably using the feedblock(s) and the multiplier in combination. The feeding amounts of layers may be adjusted as needed using a gear pump. In addition, a filter is advantageously used to remove foreign substances (foreign matter) so as to reduce film break. The extrusion temperature may vary depending on the types of materials to be used, is not critical, but is preferably 150° C. to 250° C. The coextruded polymers are rapidly cooled using a cooling drum and any other device. This can give a multilayer (laminated) unstretched film (sheet).

The film preparation step preferably includes stretching of the multilayered unstretched film so as to allow the film to offer shrinkage properties. Namely, the film preparation step preferably includes the substep of stretching the multilayered unstretched film. Examples of the stretching include, but are not limited to, biaxial stretching in a machine direction and a transverse direction; and uniaxial stretching in the machine direction or in the transverse direction. The machine direction is a direction of the film production line and is also referred to as “longitudinal direction” or “MD”. The transverse direction is a direction perpendicular to the machine direction and is also referred to as “crosswise direction” or “TD”. The stretching may be performed according to any of systems such as roll stretching, tenter stretching, and tube stretching systems. More specifically, in an embodiment, the film may be stretched in the machine direction by roll stretching at a stretching temperature of 65° C. to 100° C. to a draw ratio of 1.05 to 1.50 times; and thereafter is stretched in the transverse direction by tenter stretching at a stretching temperature of 60° C. to 100° C. (preferably 70° C. to 100° C.) to a draw ratio of 3 to 7 times (preferably 4 to 5.5 times).

The film preparation step may further include a surface treatment on a surface of the shrink film in the present invention as needed. Examples of the surface treatment include, but are not limited to, common surface treatments such as corona discharge treatment and primer treatment. The film preparation step preferably includes a surface treatment on the surface of the shrink film on which the print layer is to be formed, particularly when the shrink label according to the present invention includes a print layer on a surface of the shrink film. Specifically, when the print layer is to be provided on one surface of the shrink film, the one surface of the shrink film is preferably subjected to the surface treatment. When the print layers are to be provided on both surfaces of the shrink film, the both surfaces of the shrink film are preferably subjected to the surface treatment.

The film preparation step preferably, but not limitatively, includes a first substep, a second substep, and a third substep as follows while taking, as an example, the case in which the base layer part includes the resin layers (A) and the resin layers (B). In the first substep, a material (a), a material (b), and a material (c) are each melted. The material (a) refers to a material to constitute the resin layers (A). The material (b) refers to a material to constitute the resin layers (B). The material (c) refers to a material to constitute the surface layers. In the second substep, the material (a) and the material (b) each melted in the first substep are stacked on each other to give a laminate, and two or more laminates are further stacked to give a multilayer assembly. In the third substep, the material (c) melted in the first substep are stacked on both sides of the multilayer assembly formed in the second substep. The film preparation step may further include one or more other substeps in addition to the first substep, second substep, and third substep. The other substeps may be provided at any position (time). For example, one or more of the other substeps may be provided before the first substep, after the third substep, between the first substep and the second substep, and/or between the second substep and the third substep.

Examples of the material (a) include, but are not limited to, the materials for the resin layer (A).

Examples of the material (b) include, but are not limited to, the materials for the resin layer (B).

Examples of the material (c) include, but are not limited to, the materials for the surface layers.

In the first substep, the material (a), the material (b), and the material (c) are preferably independently melted (or melted and kneaded) using known or common extruders. For example, the material (a), the material (b), and the material (c) may be independently placed respectively into three extruders independently set at predetermined temperatures, and melted (or melted and kneaded) in the extruders. The material (a) may be extruded at an extrusion temperature not critical, but preferably 150° C. to 250° C. The material (b) may be extruded at an extrusion temperature not critical, but preferably 150° C. to 250° C. The material (c) may be extruded at an extrusion temperature not critical, but preferably 200° C. to 250° C.

In the second substep, the material (a) and the material (b) each melted in the first substep are stacked on each other to give a laminate, and two or more laminates are further stacked to give a multilayer assembly. The lamination and stacking are preferably performed using a feedblock and a multiplier in combination. The feedblock and the multiplier may each be used in a number of one, or two or more. In the second substep, the material (a) and the material (b) each melted in the first substep are stacked to give a laminate. In the second substep, two or more laminates are further stacked to give a multilayer assembly. The multilayer assembly includes layers formed from the material (a) and layers formed from the material (b) in a total number of preferably 5 to 65, and more preferably 9 to 33. The multilayer assembly given by the second substep will constitute the base layer part of the shrink film in the present invention.

In a specific embodiment, a multilayer assembly formed in the second substep by stacking the material (a) and the material (b) to give a laminate, and further stacking two or more laminates may be obtained typically in the following manner. The material (a) and the material (b) melted in the first substep are extruded using feedblocks to give a laminate having a configuration of [material (a)/material (b)/material (a)]. This laminate is also referred to as a “laminate 1”. Next, two or more plies of the laminate 1 are stacked using a multiplier, where each laminate 1 acts as a unit. This gives a multilayer assembly having a structure of [material (a)/material (b)/material (a)/material (a)/material (b)/material (a)/ . . . /material (a)/material (b)/material (a)]. This multilayer assembly is also referred to as a “multilayer assembly 2”.

In another specific embodiment, a multilayer assembly formed in the second substep by stacking the material (a) and the material (b) to give a laminate, and further stacking two or more laminates may be obtained typically in the following manner. The material (a) and the material (b) each melted in the first substep are extruded using feedblocks to give a laminate having a configuration of [material (b)/material (a)/material (b)]. The laminate is also referred to as a “laminate 3”. Next, two or more plies of the laminate 3 are stacked using a multiplier, where each laminate 3 acts as a unit. This gives a multilayer assembly having a structure of [material (b)/material (a)/material (b)/material (b)/material (a)/material (b)/ . . . /material (b)/material (a)/material (b)]. This multilayer assembly is also referred to as a “multilayer assembly 4”

In yet another specific embodiment, a multilayer assembly formed in the second substep by stacking the material (a) and the material (b) to give a laminate, and further stacking two or more laminates may be obtained typically in the following manner. The material (a) and the material (b) each melted in the first substep are extruded using feedblocks to give a laminate having a configuration of [material (a)/material (b)]. This laminate is also referred to as a “laminate 5”. Next, two or more plies of the laminate 5 are stacked using a multiplier, where each laminate 5 acts as a unit. This gives a multilayer assembly having a structure of [material (a)/material (b)/material (a)/material (b)/ . . . /material (a)/material (b)]. This multilayer assembly is also referred to as a “multilayer assembly 6”. The multilayer assembly 6 is also a multilayer assembly having a structure of [material (b)/material (a)/material (b)/material (a)/ . . . /material (b)/material (a)] when seen other way around.

In the third substep, the material (c) melted in the first substep is stacked on both sides of the multilayer assembly (e.g., any of the assemblies 2, 4, and 6) formed in the second substep. The stacking in the third substep is preferably performed using one or more feedblocks. The stacked material (c) constitutes the surface layers in the shrink film in the present invention. The third substep gives a multilayer assembly. This multilayer assembly includes the multilayer assembly formed in the second substep, and two layers of the material (c) disposed on both sides of the multilayer assembly (one layer per one side), where the material (c) has been melted in the first substep.

Though not limited, the multilayer assembly formed via the first substep, the second substep, and the third substep may be coextruded from a T-die, rapidly cooled using a cooling drum and any other device, and yield a multilayered unstretched film (sheet).

The multilayer assembly 2 having a structure of [material (a)/material (b)/material (a)/material (a)/material (b)/material (a)/ . . . /material (a)/material (b)/material (a)] is supposed to be a base layer part having a structure of [resin layer (A)/resin layer (B)/resin layer (A)/resin layer (A)/resin layer (B)/resin layer (A)/ . . . /resin layer (A)/resin layer (B)/resin layer (A)]. In fact, however, the multilayer assembly 2 constitutes a base layer part having a structure of [resin layer (A)/resin layer (B)/resin layer (A)/resin layer (B)/ . . . /resin layer (A)/resin layer (B)/resin layer (A)]. This is because stacked (laminated) portions formed by lamination of an identical material in the multilayer assembly 2, namely portions of [material (a)/material (a)], each constitute one resin layer (A). Likewise, the multilayer assembly 4 is supposed to constitute a base layer part having a structure of [resin layer (B)/resin layer (A)/resin layer (B)/resin layer (B)/resin layer (A)/resin layer (B)/ . . . /resin layer (B)/resin layer (A)/resin layer (B)]. In fact, however, the multilayer assembly constitutes a base layer part having a structure of [resin layer (B)/resin layer (A)/resin layer (B)/resin layer (A)/ . . . /resin layer (B)/resin layer (A)/the resin layer (B)]. This is because, in the multilayer assembly 4, portions formed by laminating an identical material, namely portions of [material (b)/material (b)], each constitute one resin layer (B).

Examples of the other substeps include, but are not limited to, the substep of stretching; and the substep of performing a surface treatment. Typically, but not limitatively, the film preparation step preferably further includes the substep of stretching the multilayered unstretched film prepared in the third substep. The substep of stretching is performed after the third substep.

Other Steps

The method according to the present invention for producing a shrink label may further include one or more other steps in addition to the film preparation step. Examples of the other steps include, but are not limited to, the step of providing a designed print layer; and the step of providing a background print layer.

In the step of providing a designed print layer, a printing ink is applied to at least one surface of the shrink film in the present invention, and the applied ink is solidified by drying and/or any other procedure. This forms a designed print layer. The step of providing a designed print layer may be performed using any of known or common printing techniques. Among the printing techniques, gravure printing technique and flexographic printing technique are preferred.

The printing ink may be prepared typically, but not limitatively, by mixing the binder resin, the pigment, a solvent, other additives, and any other components as needed. The mixing may be performed by a known or common procedure. Examples of mixing devices for use in the mixing include, but are not limited to, mixers such as paint shakers, butterfly mixers, planetary mixers, pony mixers, dissolvers, tank mixers, homomixers, and homo-dispers (homogenizing dispersers); mills such as roll mills, sand mills, ball mills, bead mills, and line mills; and kneaders. The mixing may be performed for a time (residence time) not critical, but preferably 10 to 120 minutes. The resulting printing ink may be filtrated as needed before use. The components (the binder resin, pigment, solvent, and any other additives) may each be used alone or in combination.

The solvent may be selected from organic solvents and any other solvents for use generally in printing inks which are used in gravure printing, flexographic printing, and any other printing. Examples of the solvent include, but are not limited to, acetic esters such as ethyl acetate, propyl acetate, and butyl acetate; alcohols such as methanol, ethanol, isopropyl alcohol, propanol, and butanol; ketones such as methyl ethyl ketone and methyl isobutyl ketone; aromatic hydrocarbons such as toluene and xylenes; aliphatic hydrocarbons such as hexane and octane; alicyclic hydrocarbons such as cyclohexane and methylcyclohexane; glycols such as ethylene glycol and propylene glycol; glycol ethers such as ethylene glycol monopropyl ether, propylene glycol monomethyl ether, and propylene glycol monobutyl ether; and glycol ether esters such as propylene glycol monomethyl ether acetate. The solvent can be removed by drying after the printing ink is applied to the shrink film in the present invention. As used herein the term “solvent” also refers to and includes a “dispersion medium”.

The step of providing a background print layer is preferably, but not limitatively, provided after the step of providing a designed print layer. In a not-limiting exemplary procedure of the step of providing a background print layer, the printing ink is applied to a surface of the shrink film in the present invention, where the surface bears the designed print layer. The applied ink is solidified typically by drying. This provides a background print layer. The step of providing a background print layer may be performed by any of known or common printing techniques. Among them, the step is preferably performed by gravure printing technique and/or flexographic printing technique.

The printing ink may be prepared by mixing the binder resin, the pigment, the solvent, the other additives, and any other components as needed with a solvent. When the background print layer is a white print layer, the pigment is preferably titanium oxide among others.

Shrink Sleeve Label Production Method

The shrink sleeve label may be produced typically, but not limitatively, by a method in which the shrink label (the shrink label according to the present invention) is shaped into a sleeve so that the main orientation direction of the shrink label be a circumferential direction of the sleeve. Specifically, both ends of the shrink label having a predetermined width in the main orientation direction are overlapped to allow the shrink label to be shaped into a sleeve. A solvent (e.g., tetrahydrofuran (THF)) or an adhesive is applied to an inner surface of one lateral end (one end) of the label in a strip about 2 to about 4 mm wide from the extremity of the one end. The solvent and the adhesive are hereinafter generically also referred to as an “adhesive component”. The portion coated with the adhesive component is bonded to the outer surface of the other lateral end (the other end) and yields a shrink sleeve label.

When the shrink sleeve label is provided with perforations to cut off the label, perforations each with a predetermined length may be formed at a predetermined pitch in a direction perpendicular to the circumferential direction. The perforations may be formed by a common procedure. For example, the perforations may be formed typically by pressing a disk-like blade peripherally having cutting ends and non-cutting portions alternately, or by using laser beams. The step (substep) of perforating may be performed at any temporal position selected as appropriate. For example, the step of perforating may be performed before or after the step of processing the label into a sleeve label.

### Labeled Container

The shrink label according to the present invention may be typically, but not limitatively, applied to a container (such as a beverage container) and be used as a labeled container. The shrink label according to the present invention may also be applied to any other adherends than containers. For example, a labeled container (a labeled container including the shrink label according to the present invention) may be prepared in the following manner. The shrink label (in particular, shrink sleeve label) according to the present invention is placed around a container so that the shrink label becomes cylindrical. The placed shrink label is thermally shrunk to be attached to the container. This gives the labeled container. Examples of the container include, but are not limited to, soft drink bottles such as PET bottles; home-delivered milk bottles; containers for foodstuffs such as seasonings; alcoholic drink bottles; containers for pharmaceutical preparations; containers for chemicals such as detergents and aerosols (sprays); containers for toiletry products; and containers for bowl noodle soups. Examples of the shape of the container include, but are not limited to, cylindrical, rectangular, and any other bottle shapes; and cup or bowl shapes. Examples of the material for the container include, but are not limited to, plastics such as PETs; glass; and metals.

The labeled container may by prepared typically, but not limitatively, by fitting the shrink sleeve label onto a predetermined container and subjecting the fit shrink sleeve label to shrink processing. In the shrink processing, the shrink sleeve label is subjected to a heat treatment. The heat treatment allows the shrink sleeve label to thermally shrink and to conform to, and to be in intimate contact with, the container. Examples of a process to perform the heat treatment include, but are not limited to, a process of allowing the work to pass through a hot-air tunnel or steam tunnel; and a process of heating the work with radiant heat from infrared rays and any other heat sources. In particular, the heat treatment is preferably performed by a process of treating the work with steam at 80° C. to 100° C. In this process, the work may be allowed to pass through a heating tunnel filled with steam and vapor. The heat treatment may also be performed using dry steam at 101° C. to 140° C. The heat treatment is performed preferably, but not limitatively, at a temperature within such a range that the shrink film has a temperature of 85° C. to 100° C. (in particular, 90° C. to 97° C.). In particular, the shrink film in the present invention can undergo a heat treatment at a high temperature. This configuration allows the shrink label to be applied to or used in containers onto which the shrink label should highly shrink. The heat treatment may be performed for a treatment time of 4 to 20 seconds. This is preferred from the viewpoints of productivity and economic efficiency.

### EXAMPLES

The present invention will be illustrated in further detail with reference to several examples below. It should be noted, however, that the examples are by no means intended to limit the scope of the present invention.

Table 1 indicates compositions of surface layer materials (materials (c)), resin layer (A) materials (materials (a)), resin layer (B) materials (materials (b)) used in the examples; configurations and evaluation results of shrink films and shrink labels prepared in the examples and a comparative example; and any other data.

### Example 1

### Materials

A material to constitute resin layers (A) (resin layer (A) material) included 100 percent by weight of a polyethylene resin A (trade name KERNEL KF360T, supplied by Japan Polyethylene Corporation).

A material to constitute resin layers (B) (resin layer (B) material) included 80 percent by weight of the polyethylene resin A (trade name KERNEL KF360T, supplied by Japan Polyethylene Corporation); and 20 percent by weight of an amorphous cycloolefin polymer (trade name TOPAS, supplied by Polyplastics Co., Ltd.).

A material to constitute surface layers (surface layer material) included 85 percent by weight of the amorphous cycloolefin polymer (trade name TOPAS, supplied by Polyplastics Co., Ltd.); and 15 percent by weight of the polyethylene resin A (trade name KERNEL KF360T, supplied by Japan Polyethylene Corporation).

Shrink Film

The resin layer (A) material, the resin layer (B) material, and the surface layer material were charged respectively into an extruder “a” heated at 220° C., an extruder “b” heated at 220° C., and an extruder “c” heated at 250° C. The materials were melted and extruded using the three extruders. The molten resin layer (A) material and the molten resin layer (B) material were divided, merged, and stacked using a lamination apparatus. The lamination apparatus included feedblocks for emerging to form two-component three layers in combination with an eight-manifold multiplier (supplied by Nordson Extrusion Dies Industries, LLC.). In the process, a two-component three-layer configuration of [resin layer (A) material/resin layer (B) material/resin layer (A) material] (A/B/A) acted as one constitutional repeating unit. The process gave a multilayer assembly (I). The multilayer assembly (I) included eight constitutional repeating units each having the two-component three-layer configuration and being stacked on each other (in a repeating number of eight). Next, the molten surface layer material was merged with and stacked on both sides of the multilayer assembly (I) to form surface layers. This gave a multilayer assembly (II). Further, the multilayer assembly (II) was extruded from a T-die, rapidly cooled on a casting drum cooled at 25° C., and yielded a multilayered unstretched film including 19 layers. The base layer part was formed by laminating the constitutional repeating unit having the two-component three-layer configuration in a repeating number of eight and was supposed to include 24 layers. In fact, however, two adjacent layers of the resin layer (A) material were combined to form one layer. Thus, the resulting base layer part had a 17-layer configuration of (A/B/A/B/A/B/A/B/A/B/A/B/A/B/A/B/A).

Next, the multilayered unstretched film was subjected to tenter stretching at 85° C. to a draw ratio of 4 times in a transverse direction. This gave a continuous (long) stretched film (shrink film) that had been mainly stretched in the transverse direction and had heat shrinkability in the transverse direction.

Shrink Label

The above-prepared continuous shrink film was subjected to printing using a gravure printing machine to form a designed print layer and a white background print layer. This gave a continuous shrink label.

Shrink Sleeve Label

Next, the continuous shrink label was slit to a predetermined width, and one end of the slit shrink label was laid on the other end so that the transverse direction be a circumferential direction. A shrink film surface in one end was seamed with a shrink film surface in the other end with a solvent. This gave a continuous shrink sleeve label. The continuous shrink sleeve label (continuous label) was cut to an individual label size and yielded shrink sleeve labels.

### Examples 2 to 11 and Comparative Example 1

Shrink films, shrink labels, and shrink sleeve labels were prepared by the procedure of Example 1, except for changing factors such as the compositions and compositional ratios of the material (a), the material (b), and the material (c), and the layer configuration of the base layer part, as indicated in Table 1. The constitutional repeating unit employed in Examples 2, 6, 9, and 10 was a constitutional repeating unit having a two-component three-layer configuration of [resin layer (B) material/resin layer (A) material/resin layer (B) material] (B/A/B). The polyethylene resin A had a density of 0.898 g/cm³. A polyethylene resin C had a density of 0.913 g/cm³. A polypropylene resin A had a density of 0.874 g/cm³.

Evaluations

The shrink films prepared in the examples and the comparative example were evaluated as follows. Evaluation results are given in Table 1.

### (1) Compressive Strength (Stiffness) (Ring Crush Method)

The shrink films (before shrink processing) prepared in the examples and the comparative example were evaluated. The shrink films were examined to measure a compressive strength in conformity to JIS P 8126. The compressive atrength of shrink films were measured as compressive strength of the shrink labels. The measurement direction was the machine direction of the shrink films.

Measuring apparatus: Autograph (AGS-50G with a load cell of 500 N) supplied by Shimadzu Corporation

Sample size: 15 mm (machine direction) by 152.4 mm (transverse direction: main orientation direction)

Testing number: 5

The compressive strength was evaluated according to criteria as follows:

Good compressive strength (good): equal to or more than 1.3 N; and

Poor compressive strength (poor): less than 1.3 N

### (2) Breaking Strength (Stretchability)

The unstretched films before stretching, corresponding to the shrink films in the examples and the comparative example, were subjected to tenter stretching in the transverse direction at 85° C. to a draw ratio of 4 times. After the stretching, whether the stretched films were broken was determined. Based on this, the stretchability was evaluated according to criteria as follows:

Good stretchability (good): the film was not broken; and

Poor stretchability (poor): the film was broken.

### (3) Haze (Transparency)

The shrink labels prepared in the examples and comparative example were cut to label pieces of a size of 100 mm (machine direction; direction perpendicular to the main orientation direction) by 150 mm (transverse direction; main orientation direction). The label pieces were used as measurement samples.

The measurement samples were examined to measure a haze using HAZE-GARD II supplied by Toyo Seiki Seisaku-Sho Ltd. in conformity to JIS K 7136.

The transparency was evaluated according to criteria as follows:

Good transparency (good): haze of equal to or less than 6%; and

Poor transparency (poor): haze of more than 6%.

### (4) Heat Shrinkage Percentage (90° C., 10 sec.)

Measurement of the heat shrinkage percentage (90° C., 10 sec.) will be illustratively described.

The shrink films (before shrink processing) prepared in the examples and the comparative example were cut to give rectangular sample pieces. The sample pieces each had a length of 120 mm (gauge length of 100 mm) in the measurement direction and a width of 5 mm. The measurement direction is the main orientation direction (the machine direction or transverse direction of the base film).

The sample pieces were each subjected to a heat treatment in hot water at 90° C. for 10 seconds (under no load). The difference in gauge length between before and after the heat treatment was read, based on which the heat shrinkage percentage was calculated according to a computational expression as follows:

Shrinkage Percentage (%)=(L₀−L₁)/L₀×100

wherein L₀ represents a dimension (in the main orientation direction, namely, in the machine direction or transverse direction) of the sample before the heat treatment; and L₁ represents a dimension (in the same direction as with L₀) of the sample after the heat treatment.

The shrinkage properties were evaluated from the heat shrinkage percentage (shrinkage percentage) in the main orientation direction according to criteria as follows. The main orientation directions in the examples were each the transverse direction of the shrink film.

Very good heat shrinkability (VG): shrinkage percentage of equal to or more than 50%;

Good heat shrinkability (good): shrinkage percentage of from 40% to less than 50%; and

Poor heat shrinkability (poor): shrinkage percentage of less than 40%.

TABLE 1

| | | | Com. | | | | | | |
|---|---|---|---|---|---|---|---|---|---|
| Material | | Trade name | Ex. 1 | Ex. 1 | Ex. 2 | Ex. 3 | Ex. 4 | Ex. 5 | Ex. 6 |
| Content | Amorphous cycloolefin | TOPAS | 85 | 85 | 85 | 85 | 85 | 85 | 85 |
| (weight | polymer | | | | | | | | |
| percent) in | Polyethylene resin A | KERNEL KF360T | 15 | 15 | | 15 | 15 | 15 | 15 |
| material (c) | Polyethylene resin D | Evolue SP0540 | | | 15 | | | | |
| (surface | | | | | | | | | |
| layers) | | | | | | | | | |
| Content | Polyethylene resin A | KERNEL KF360T | 80 | 80 | | 80 | | | |
| (weight | Polyethylene resin B | KERNEL KF260T | | | | | 4 | | |
| percent) in | Polyethylene resin C | UMERIT 1540F | | | | | | | |
| material (b) | Polyethylene resin D | Evolue SP0540 | | | 80 | | | | |
| (resin layer | Polypropylene resin A | Vistamaxx 3020FL | | | | | | | |
| (B)) | Polypropylene resin C | Vistamaxx 3980FL | | | | | | | |
| | Ionomer | HIMILAN | | | | | | 100 | 100 |
| | Amorphous cycloolefin | TOPAS | 20 | 20 | 20 | 20 | 20 | | |
| | polymer | | | | | | | | |
| | Polypropylene resin B | WINTEC WFX6 | | | | | 56 | | |
| | Petroleum resin | ARKON P125 | | | | | 20 | | |
| Content | Polyethylene resin A | KERNEL KF360T | 100 | 100 | | | | 80 | 80 |
| (weight | Polyethylene resin B | KERNEL KF260T | | | | | 5 | | |
| percent) in | Polyethylene resin C | UMERIT 1540F | | | | 100 | | | |
| material (a) | Polyethylene resin D | Evolue SP0540 | | | 100 | | | | |
| (resin layer | Polypropylene resin A | Vistamaxx 3020FL | | | | | | | |
| (A)) | Polypropylene resin C | Vistamaxx 3980FL | | | | | | | |
| | Amorphous cycloolefin | TOPAS | | | | | | 20 | 20 |
| | polymer | | | | | | | | |
| | Polypropylene resin B | WINTEC WFX6 | | | | | 70 | | |
| | Petroleum resin | ARKON P125 | | | | | 25 | | |

| | | | | | | | | |
|---|---|---|---|---|---|---|---|---|
| Thickness | Surface layers | 3.00 | 3.00 | 3.00 | 3.00 | 3.00 | 3.00 | 3.00 |
| per layer | Resin layer(s) (B)* | 18.00 | 2.25 | 0.75 | 2.25 | 2.25 | 2.25 | 0.75 |
| (μm) | Resin layers (A)* | 3.00 | 0.75 | 2.25 | 0.75 | 0.75 | 0.75 | 2.25 |

| | | | | | | | |
|---|---|---|---|---|---|---|---|
| Outermost layer of base layer part | Layer A | Layer A | Layer B | Layer A | Layer A | Layer A | Layer B |
| Constitutional repeating unit | A/B/A | A/B/A | B/A/B | A/B/A | A/B/A | A/B/A | B/A/B |
| Number of repeating unit including resin layer | 1 | 8 | 8 | 8 | 8 | 8 | 8 |
| (A) and resin layer (B) (repeating number) | | | | | | | |
| (Total thickness of resin layers (A)):(Total thickness of | 1:3:1 | 1:3:1 | 1:3:1 | 1:3:1 | 1:3:1 | 1:3:1 | 3:1:1 |
| resin layer(s) (B)):(Total thickness of surface layers) | | | | | | | |
| Total thickness of shrink film (μm) | 30 | 30 | 30 | 30 | 30 | 30 | 30 |
| Stretching conditions | 85° C., 4 | 85° C., 4 | 85° C., 4 | 85° C., 4 | 85° C., 5 | 85° C., 4 | 85° C., 4 |
| | times | times | times | times | times | times | times |
| Compressive strength (N) (stiffness) | Poor | Good | Good | Good | Good | Good | Good |
| Haze (%) (transparency) | Poor | Good | Good | Good | Good | Good | Good |
| Density of shrink film (g/cm³) | 0.931 | 0.931 | 0.926 | 0.934 | 0.946 | 0.953 | 0.941 |
| Heat shrinkage percentage (%) | VG | Good | VG | VG | VG | VG | VG |
| Stretchability | Good | Good | Good | Good | Good | Good | Good |

| Material | | Trade name | Ex. 7 | Ex. 8 | Ex. 9 | Ex. 10 | Ex. 11 |
|---|---|---|---|---|---|---|---|
| Content | Amorphous cycloolefin | TOPAS | 85 | 85 | 85 | 85 | 85 |
| (weight | polymer | | | | | | |
| percent) in | Polyethylene resin A | KERNEL KF360T | 15 | 15 | 15 | 15 | 15 |
| material (c) | Polyethylene resin D | Evolue SP0540 | | | | | |
| (surface | | | | | | | |
| layers) | | | | | | | |
| Content | Polyethylene resin A | KERNEL KF360T | | | | | |
| (weight | Polyethylene resin B | KERNEL KF260T | | | | | |
| percent) in | Polyethylene resin C | UMERIT 1540F | 80 | | | | |
| material (b) | Polyethylene resin D | Evolue SP0540 | | | | 53 | 53 |
| (resin layer | Polypropylene resin A | Vistamaxx 3020FL | | 80 | | | |
| (B)) | Polypropylene resin C | Vistamaxx 3980FL | | | 80 | 16 | 16 |
| | Ionomer | HIMILAN | | | | | |
| | Amorphous cycloolefin | TOPAS | 20 | 20 | 20 | 31 | 31 |
| | polymer | | | | | | |
| | Polypropylene resin B | WINTEC WFX6 | | | | | |
| | Petroleum resin | ARKON P125 | | | | | |
| Content | Polyethylene resin A | KERNEL KF360T | 80 | | | | |
| (weight | Polyethylene resin B | KERNEL KF260T | | | | | |
| percent) in | Polyethylene resin C | UMERIT 1540F | | | | | |
| material (a) | Polyethylene resin D | Evolue SP0540 | | | | 100 | 100 |
| (resin layer | Polypropylene resin A | Vistamaxx 3020FL | | 100 | | | |
| (A)) | Polypropylene resin C | Vistamaxx 3980FL | | | 100 | | |
| | Amorphous cycloolefin | TOPAS | 20 | | | | |
| | polymer | | | | | | |
| | Polypropylene resin B | WINTEC WFX6 | | | | | |
| | Petroleum resin | ARKON P125 | | | | | |

| | | | | | | |
|---|---|---|---|---|---|---|
| Thickness | Surface layers | 3.00 | 3.00 | 3.00 | 3.00 | 3.00 |
| per layer | Resin layer(s) (B)* | 2.25 | 2.25 | 0.75 | 0.75 | 2.25 |
| (μm) | Resin layers (A)* | 0.75 | 0.75 | 2.25 | 2.25 | 0.75 |

| | | | | | |
|---|---|---|---|---|---|
| Outermost layer of base layer part | Layer A | Layer A | Layer B | Layer B | Layer A |
| Constitutional repeating unit | A/B/A | A/B/A | B/A/B | B/A/B | A/B/A |
| Number of repeating unit including resin layer | 8 | 8 | 8 | 8 | 8 |
| (A) and resin layer (B) (repeating number) | | | | | |
| (Total thickness of resin layers (A)):(Total thickness of | 1:3:1 | 1:3:1 | 1:3:1 | 1:3:1 | 1:3:1 |
| resin layer(s) (B)):(Total thickness of surface layers) | | | | | |
| Total thickness of shrink film (μm) | 30 | 30 | 30 | 30 | 30 |
| Stretching conditions | 85° C., 4 | 85° C., 4 | 85° C., 4 | 85° C., 4 | 85° C., 4 |
| | times | times | times | times | times |
| Compressive strength (N) (stiffness) | Good | Good | Good | Good | Good |
| Haze (%) (transparency) | Good | Good | Good | Good | Good |
| Density of shrink film (g/cm³) | 0.937 | 0.914 | 0.907 | 0.927 | 0.939 |
| Heat shrinkage percentage (%) | VG | VG | VG | VG | VG |
| Stretchability | Good | Good | Good | Good | Good |

*The resin layer (A) or the resin layer (B) has a thickness half the thickness given in the table when the layer constitutes the outermost layer of the base layer part.

As is seen from Table 1, the shrink films in the shrink labels according to the present invention (Examples 1 to 11) had excellent stretchability. The shrink labels each had a low specific gravity and offered transparency and stiffness at excellent levels. In contrast, the shrink label according to Comparative Example 1 included resin layers (A) and a resin layer (B) in a total number of 3 in the base layer part. This shrink label had inferior stiffness and inferior transparency as compared with the shrink labels according to the examples.

### INDUSTRIAL APPLICABILITY

Since the shrink labels according to the present invention have the specific configurations, the shrink labels each have a low specific gravity, offer excellent stiffness even when having a reduced thickness, and have transparency and heat shrinkability at excellent levels. The shrink films have excellent stretchability, and the shrink labels according to the present invention resist natural contraction. These configurations allow the shrink labels according to the present invention to be applied to beverage containers and any other containers and to be used as labeled containers. The shrink labels according to the present invention may also be applied to other adherends than containers. For example, the shrink label (in particular, the shrink sleeve label) according to the present invention is placed cylindrically around a container, and the cylindrical shrink label around the container is thermally shrunk to be attached to the container. This gives a labeled container (a labeled container labeled with the shrink label according to the present invention).

### REFERENCE SIGNS LIST

1 shrink film in the present invention
11 surface layer
12 base layer part
12a resin layer (A)
12b resin layer (B)
2 print layer
3 shrink label according to the present invention
4 shrink sleeve label according to the present invention
41 seam
D circumferential direction
51 background print layer
52 designed print layer
53 solvent or adhesive

1. A shrink label comprising:
a shrink film,
the shrink film including:
a base layer part; and
surface layers disposed on or over both sides of the base layer part,
the surface layers each containing an amorphous cycloolefin polymer in a content of equal to or more than 50 percent by weight,
the base layer part including
9 to 65 layers, the layers including
at least 4 layers of resin layer (A) containing at least a polyethylene resin or a polypropylene resin in a content of equal to or more than 50 percent by weight.

2.-6. (canceled)

7. The shrink label according to claim 1,
wherein the resin layer (A) is at least one resin layer selected from resin layers (I), (II), and (III), wherein:
the resin layer (I) is a resin layer that contains an LLDPE in a content of equal to or more than 50 percent by weight based on the total weight of the resin layer (A);
the resin layer (II) is a resin layer that contains a metallocene-catalyzed polypropylene in a content of equal to or more than 50 percent by weight based on the total weight of the resin layer (A); and
the resin layer (III) is a resin layer that contains an LLDPE and a metallocene-catalyzed polypropylene and the total content of the LLDPE and the metallocene-catalyzed polypropylene is equal to or more than 50 percent by weight based on the total weight of the resin layer (A).

8. The shrink label according to claim 1,
wherein the base layer part further include at least 4 layers of resin layer (B), and
wherein the resin layer (B) is a resin layer containing at least one resin selected from the group consisting of a poryolefine resin, an amorphous cycloolefin polymer, and an ionomer.

9. The shrink label according to claim 8,
wherein the resin layer (B) is at least one resin layer selected from resin layers (i), (ii), (iii), (iv), and (v), wherein:
the resin layer (i) is a resin layer that contains an ionomer in a content of equal to or more than 50 percent by weight based on the total weight of the resin layer (B);
the resin layer (ii) is a resin layer that contains an amorphous cycloolefin polymer equal to or more than 50 percent by weight based on the total weight of the resin layer (B);
the resin layer (iii) is a resin layer that contains an amorphous cycloolefin polymer and an LLDPE, the content of the amorphous cycloolefin polymer is 10 to 70 percent by weight based on the total weight of the resin layer (B), and the content of the LLDPE is 30 to 90 percent by weight based on the total weight of the resin layer (B);
the resin layer (iv) is a resin layer that contains an amorphous cycloolefin polymer and a metallocene-catalyzed polypropylene, the content of the amorphous cycloolefin polymer is 10 to 70 percent by weight based on the total weight of the resin layer (B), and the content of the metallocene-catalyzed polypropylene is 30 to 90 percent by weight based on the total weight of the resin layer (B); and
the resin layer (v) is a resin layer that contains an amorphous cycloolefin polymer, an LLDPE, and a metallocene-catalyzed polypropylene, the content of the amorphous cycloolefin polymer is 10 to 70 percent by weight based on the total weight of the resin layer (B), the content of the LLDPE is 10 to 85 percent by weight based on the total weight of the resin layer (B), and the content of the metallocene-catalyzed polypropylene is 1 to 80 percent by weight based on the total weight of the resin layer (B).

10. The shrink label according to claim 8,
wherein the resin layer (B) is a resin layer containing at least one of an amorphous cycloolefin polymer and an ionomer; and
a total content of the amorphous cycloolefin polymer and the ionomer in the resin layer (B) is higher than a total content of an amorphous cycloolefin polymer and an ionomer in the resin layer (A).

11. The shrink label according to claim 8,
wherein the resin layer (B) is a resin layer containing a polyolefin resin; and
the polyolefin resin in the resin layer (B) has a density higher than a density of the polyolefin resin in the resin layer (A).

12. The shrink label according to claim 8, wherein the base layer part has two or more interfaces each between an adjacent pair of the resin layer (A) and the resin layer (B).

13. The shrink label according to claim 8, wherein a difference in density between the resin layer (B) and the resin layer (A) is equal to or more than 0.005 g/cm³.

14. The shrink label according to claim 8, wherein the base layer part includes the resin layers (A) and the resin layers (B) disposed in alternate order in a total number of 9 to 65.

15. The shrink label according to claim 7,
wherein the base layer part further include at least 4 layers of resin layer (B), and
wherein the resin layer (B) is a resin layer containing at least one resin selected from the group consisting of a poryolefine resin, an amorphous cycloolefin polymer, and an ionomer.

16. The shrink label according to claim 15,
wherein the resin layer (B) is a resin layer containing at least one of an amorphous cycloolefin polymer and an ionomer; and
a total content of the amorphous cycloolefin polymer and the ionomer in the resin layer (B) is higher than a total content of an amorphous cycloolefin polymer and an ionomer in the resin layer (A).

17. The shrink label according to claim 15,
wherein the resin layer (B) is a resin layer containing a polyolefin resin; and
the polyolefin resin in the resin layer (B) has a density higher than a density of the polyolefin resin in the resin layer (A).

18. The shrink label according to claim 15, wherein the base layer part has two or more interfaces each between an adjacent pair of the resin layer (A) and the resin layer (B).

19. The shrink label according to claim 15, wherein a difference in density between the resin layer (B) and the resin layer (A) is equal to or more than 0.005 g/cm³.

20. The shrink label according to claim 15, wherein the base layer part includes the resin layers (A) and the resin layers (B) disposed in alternate order in a total number of 9 to 65.

21. The shrink label according to claim 15,
wherein the resin layer (B) is at least one resin layer selected from resin layers (i), (ii), (iii), (iv), and (v), wherein:
the resin layer (i) is a resin layer that contains an ionomer in a content of equal to or more than 50 percent by weight based on the total weight of the resin layer (B);
the resin layer (ii) is a resin layer that contains an amorphous cycloolefin polymer equal to or more than 50 percent by weight based on the total weight of the resin layer (B);
the resin layer (iii) is a resin layer that contains an amorphous cycloolefin polymer and an LLDPE, the content of the amorphous cycloolefin polymer is 10 to 70 percent by weight based on the total weight of the resin layer (B), and the content of the LLDPE is 30 to 90 percent by weight based on the total weight of the resin layer (B);
the resin layer (iv) is a resin layer that contains an amorphous cycloolefin polymer and a metallocene-catalyzed polypropylene, the content of the amorphous cycloolefin polymer is 10 to 70 percent by weight based on the total weight of the resin layer (B), and the content of the metallocene-catalyzed polypropylene is 30 to 90 percent by weight based on the total weight of the resin layer (B); and
the resin layer (v) is a resin layer that contains an amorphous cycloolefin polymer, an LLDPE, and a metallocene-catalyzed polypropylene, the content of the amorphous cycloolefin polymer is 10 to 70 percent by weight based on the total weight of the resin layer (B), the content of the LLDPE is 10 to 85 percent by weight based on the total weight of the resin layer (B), and the content of the metallocene-catalyzed polypropylene is 1 to 80 percent by weight based on the total weight of the resin layer (B).

22. The shrink label according to claim 21, wherein a difference in density between the resin layer (B) and the resin layer (A) is equal to or more than 0.005 g/cm³.

23. The shrink label according to claim 21, wherein the base layer part includes the resin layers (A) and the resin layers (B) disposed in alternate order in a total number of 9 to 65.

24. The shrink label according to claim 22, wherein the base layer part includes the resin layers (A) and the resin layers (B) disposed in alternate order in a total number of 9 to 65.
